(19) United States
(12) Patent Application Publication
(10) Pub. No.: US 2025/0279880 A1
(43) Pub. Date: Sep. 4, 2025

(54) METHOD, APPARATUS, AND COMPUTER READABLE MEDIUM FOR ENCRYPTION KEY MANAGEMENT

(71) Applicant: INFORMATICA LLC, Redwood City, CA (US)

(72) Inventor: Igor BALABINE, Menlo Park, CA (US)

(21) Appl. No.: 18/591,303

(22) Filed: Feb. 29, 2024

(51) Int. Cl. H04L 9/08

(52) U.S. Cl. CPC H04L 9/0822

(57) ABSTRACT

A method for encryption key management executed by one or more computing devices of a management system includes receiving an encryption request from an application, the encryption request including a request to encrypt at least one data object, the application associated with a corresponding user, determining a usage metric of each of a plurality of existing encryption keys associated with the corresponding user, each usage metric comprising a number of data objects encrypted by a respective existing encryption key, determining whether to transmit an existing encryption key in the plurality of existing encryption keys to the application or to transmit instructions to the application configured to cause the application to generate a new encryption key, and transmitting, to the application, either the existing encryption key or the instructions configured to cause the application to generate the new encryption key.

### FIELD

The present disclosure relates generally to cryptography and in particular to management of cryptographic keys.

### BACKGROUND

In digital cryptography, cryptographic keys are used to encrypt plaintext data to generate encrypted ciphertext data and to decrypt the encrypted ciphertext data to generate the plaintext data.

When a cryptographic key is generated and used to encrypt plaintext, only that cryptographic key can be used can be used to decrypt the resulting ciphertext back into the original plaintext. As such, these cryptographic keys must be stored and must be accessible for later use in decryption. This can be difficult, as it requires tracking multiple that can be stored in multiple storage, and becomes particularly difficult when a user is an enterprise or other organization seeking to protect large amounts of data, as the number of cryptographic keys being managed can be on the order of millions and even billions.

Fewer cryptographic keys can be used, which makes management easier. However, using fewer cryptographic keys can mean that larger volumes of data are encrypted with a given cryptographic key. If just one cryptographic key is compromised, due to an attack from a malicious actor, or simply lost, then the large volume of data encrypted by that cryptographic key can be considered compromised or lost as well.

### SUMMARY

In some aspects, the present disclosure relates to a method executed by one or more computing devices for efficiently indexing encrypted data, the method comprising: receiving an encryption request from an application, the encryption request comprising a request to encrypt at least one data object, wherein the application is associated with a corresponding user; determining a usage metric of each of a plurality of existing encryption keys associated with the corresponding user, each usage metric comprising a number of data objects encrypted by a respective existing encryption key; determining whether to transmit an existing encryption key in the plurality of existing encryption keys to the application or to transmit instructions to the application configured to cause the application to generate a new encryption key, the determination being based at least in part on a probabilistic model, the usage metric for each of the plurality of existing encryption keys, and a data loss threshold associated with the corresponding user; and transmitting, to the application, either the existing encryption key or the instructions configured to cause the application to generate the new encryption key.

Where the step of transmitting, to the application, either the existing encryption key or the instructions configured to cause the application to generate the new encryption key comprises transmitting the existing encryption key, the step can further include the steps of: selecting the existing encryption key from an encryption key repository; and transmitting an encryption key container corresponding to the selected existing encryption key to the application, wherein the encryption key container is an encrypted data object containing the selected existing encryption key.

In some aspects, the encryption key container can comprise: an encrypted encryption key corresponding to the selected existing encryption key, wherein the encrypted encryption key is encrypted with a key encryption key; an encrypted container wrapper comprising the key encryption key and a checksum of the encrypted encryption key, wherein the encrypted container wrapper is encrypted with a master key associated with the user; and an augmented associated data object comprising metadata corresponding to the selected existing encryption key, the corresponding user, and the master key used to encrypt the encrypted container wrapper.

Where the step of transmitting, to the application, either the existing encryption key or the instructions configured to cause the application to generate the new encryption key comprises transmitting the instructions configured to cause the application to generate the new encryption key, the step can further include the steps of receiving, from the application, an encryption key container corresponding to the new encryption key generated by the application, wherein the encryption key container is an encrypted data object containing the new encryption key generated by the application; and storing the encryption key container corresponding to the new encryption key generated by the application

In some aspects, the instructions configured to cause the application to generate a new encryption key are further configured to cause the application to: generate an encryption key container corresponding to the new encryption key, wherein the encryption key container is an encrypted data object containing the new encryption key; and encrypt the data object with the new encryption key.

In some aspects, the instructions configured to cause the application to generate the encryption key container corresponding to the new encryption key are configured to cause the application to: generate a key encryption key; encrypt the new encryption key with the key encryption key to generate an encrypted encryption key; determine a checksum of the encrypted encryption key; concatenate the key encryption key and the checksum of the encrypted encryption key to generate a container wrapper; transmit the container wrapper and an associated data object to the management system, wherein the associated data object comprises metadata about the new encryption key and the corresponding user; receive, from the management system, an encrypted container wrapper and an augmented associated data object, wherein the encryption key encryption key is encrypted by the management system with a master encryption key associated with the corresponding user, and wherein the augmented associated data object comprises metadata corresponding to the new encryption key, the corresponding user, and the master key; and concatenate the augmented associated data object, the encrypted container wrapper, and the encrypted encryption key to generate the encryption key container.

The step of determining whether to transmit an existing encryption key in the plurality of existing encryption keys to the application or to transmit instructions to the application configured to cause the application to generate a new encryption key can further include determining a probability that that use of an existing encryption key to encrypt the data object will cause the data loss threshold associated with the corresponding user to be exceeded based at least in part on the usage metric for each of the plurality of existing encryption keys, a total number of existing encryption keys associated with the corresponding user, and the data loss threshold associated with the corresponding user; determining whether the probability exceeds a threshold probability value; and determining whether to transmit an existing encryption key in the plurality of existing encryption keys to the application or to transmit instructions to the application configured to cause the application to generate a new encryption key based at least in part on whether the probability exceeds the threshold probability value.

In some aspects, the present disclosure relates to an apparatus for encryption key management. The apparatus includes one or more processors and one or more memories operatively coupled to at least one of the one or more processor and having instructions stored thereon that, when executed by at least one of the one or more processors, cause at least one of the one or more processors to perform any of the method described above.

In some aspects, the present disclosure relates to at least one non-transitory computer-readable medium storing computer-readable instructions that, when executed by at least one of one or more computing devices, cause at least one of the one or more computing devices to perform any of the methods described above.

### BRIEF DESCRIPTION OF THE DRAWINGS

FIG. 1 illustrates a computing environment for managing cryptographic key usage according to an exemplary embodiment.

FIG. 2 illustrates a secrets management service (SMS) according to an exemplary embodiment.

FIG. 3A illustrates a key management service (KMS) according to an exemplary embodiment.

FIG. 3B illustrates a distribution and management of master keys by the KMS of FIG. 3A according to an exemplary embodiment.

FIG. 4 illustrates a flowchart of a method for encrypting a data object according to an exemplary embodiment.

FIGS. 5A and 5B illustrate a table and chart of a distribution of exportable keys to a user according to an exemplary embodiment.

FIGS. 6A illustrates a flowchart for a method for transmitting instructions to an application that cause the application to generate a new exportable key according to an exemplary embodiment.

FIGS. 6B-6F illustrate the method of FIG. 6A according to an exemplary embodiment.

FIG. 7A illustrates a flowchart of a method for providing an existing exportable key to an application according to an exemplary embodiment

FIG. 7B illustrates the method of FIG. 7A according to an exemplary embodiment.

FIG. 8A illustrates flowchart of a method for encrypting a data encrypting a data object using an exportable key according to an exemplary embodiment

FIGS. 8B-8C illustrate the method of FIG. 8A according to an exemplary embodiment.

FIG. 9A illustrates a flowchart of a method for constructing an exportable key envelope according to an exemplary embodiment

FIGS. 9B-9F illustrate the method of FIG. 9A according to an exemplary embodiment.

FIG. 10A illustrates a flowchart of a method for deconstructing an exportable key envelope according to an exemplary embodiment.

FIGS. 10B-10E illustrate the method of FIG. 10A according to an exemplary embodiment.

FIG. 11A illustrates a flowchart of a method for decrypting an encrypted data object according to an exemplary embodiment.

FIG. 11B illustrates the method of claim 11A according to an exemplary embodiment.

FIG. 12 illustrates a specialized computing environment for encrypting and decrypting a data object with an exportable key, constructing and deconstructing an exportable key envelope, and generating encryption keys according to an exemplary embodiment.

### DETAILED DESCRIPTION

In digital cryptography, protection of data relies on two key pillars: the secure cryptographic process by which data is protected and the management of the cryptographic keys used to encrypt the data. These cryptographic keys serve as the access to protected data, allowing users to access encrypted data that, without such cryptographic key, would not be accessible.

In managing cryptographic keys, many problems arise due to, among other things, usage requirements/limitations for the cryptographic keys and the environment in which the cryptographic keys are created and maintained.

Cryptographic keys are susceptible to wear out due to overuse because overuse of a key can create enough data for staging ciphertext-based attacks and increases the level of data exposure or loss if a cryptographic key is compromised. Furthermore, some cryptographic modes, such as AES-GCM (Advanced Encryption Standard-Galois/Counter Mode), have intrinsic limitations on the number of times and a total amount of data a given cryptographic key may be used to encrypt.

Based on intrinsic limitations of cryptographic modes, a key management policy can define when a cryptographic key may be considered overused by defining a limit on the number of uses for a given key or an amount of data encrypted with a given key. These key management policies can govern for how long a cryptographic key may be used. These key management policies can define usage periods, sometimes referred to as “cryptoperiods,” that define how long a key may be used for data encryption as well as how long the key may be retained for decryption of corresponding ciphertexts (i.e., data encrypted by the key). For example, the National Institute of Standards and Technology provides guidance for cryptographic key management, such as in NIST Special Publication 800-57 Part 1, Revision 5, titled “Recommendation for Key Management,” the entirety of which is expressly incorporated by reference herein.

Thus, once a key reaches a recommended utilization threshold, its usage for encrypting data should be suspended and a new key should be provided for further encryption of data. The procedure of changing an encryption key to a new one is sometimes referred to as “key rotation.”

Historically, to protect user data, service providers issue users, including enterprises and other organizations and institutions, cryptographic keys of two types which may be referred to as Master Keys (MK) and Application Managed Keys (AMK). The MK is generated by the service provider, resides in the possession of the service provider, and is used by the service provider to perform cryptographic operations within the boundary of the service provider. The AMK is also generated by the service provider but may be exported from the service provider's key management facility and used by a user to encrypt and decrypt the data locally within the boundary of an application. Loss of an AMK implies loss of all customer data and metadata encrypted with the lost AMK. While being convenient for the user to keep an AMK with particular applications using the key, such key management violates cryptographic key management requirements and grossly endangers customer data privacy.

Further, while usage of the MKs may be easily tracked, usage of the AMKs is uncontrolled because the service provider has no mechanism to track the AMK utilization. Usage can be difficult to manage because encryption occurs locally with an application, so the service provider does not have visibility into its usage, and a key may be used to encrypt data of varying sizes. And the absence of tracking the AMKs can make it more difficult to track the location of the AMK for forensic investigations in the event of data compromise. Furthermore, use of a key, such as an AMK, for multiple purposes, such as for encryption and for hashing, can compromise a key because a repurposed key can lead to loss of both data privacy and data integrity.

Furthermore, uncontrolled keys may be lost due to personnel negligence, inadequate backup procedures, leakage while in transit through network proxies, or theft by a malicious intruder. If a cryptographic key is compromised, all data encrypted with that cryptographic key is considered compromised as well. Since usage of the compromised key is not tracked, it is very hard, often impossible to determine the scope of the incident and a common practice is to consider all data encrypted by the compromised key as compromised. And while use of more keys can reduce the risk of key loss, as less data is encrypted with each key, managing a collection of the keys is not a viable solution in large scale implementations (e.g., infrastructure costs, maintaining integrity of the keys, etc.).

To help with maintaining the integrity of the cryptographic keys, service providers may store the cryptographic keys in their possession on their premises and perform encryption of user data themselves. This, however, requires users to transmit their un-encrypted data from their premises to the service provider, often over a public network like the Internet. This increases the risk of data compromise, as transmission of data exposes the data to additional vulnerabilities, such as a man in the middle attack that can occur during transit.

Once a cryptographic key is generated, it can be used, transmitted, and stored. When in storage, in transit, or in use, the keys must be adequately protected, often using other cryptographic means separate from the cryptographic means used to generate the key in the first place. For example, when a key is stored or otherwise at rest (i.e., not in use or in transit), the key itself may be encrypted with another cryptographic key, sometimes referred to as a “wrapping key” in order to protect the confidentiality and integrity of the key. When a key is in transit, the key may be protected by an appropriate secure transport protocol, such as, TLS (Transport Layer Security). Communicating parties may also establishing a shared encryption key by means of public key cryptography, such as according to the DHKE (Diffie-Hellman key exchange) protocol. When a key is in use, the key may be subject to a “burn-in” effect if stored in a memory for a long time or subject to other hardware-based vulnerabilities that could expose the cryptographic keys, such as Heartbleed, Flip Feng Shui, and Meltdown/Spectre vulnerabilities. Alternatively, an attacker may stage a memory dump attack, which creates a copy of the data stored in memory on disk.

Known solutions to prevent such disclosure involve splitting the cryptographic key into multiple parts and storing those parts in separate storage locations, which requires an attacker to infiltrate all storage locations and obtain all parts to expose the full cryptographic key and access the corresponding plaintext. However, this solution can be problematic for users encrypting their data, as it requires tracking multiple key parts in multiple storage locations and associating each key part with its other key parts in order to return the key parts together when access to the full cryptographic key is required. This management of the key parts becomes particularly difficult when the user is an enterprise or other organization seeking to protect large amounts of data, as the number of cryptographic keys and key parts being managed can be on the order of millions and even billions.

Thus, a solution is needed to overcome the drawbacks articulated above. In particular, there is a need for an efficient key management system that increases data integrity and safety by taking advantage of the increased security of using more than one cryptographic key to encrypt a user's data while also securely and efficiently managing existing cryptographic key usage for users so that they can encrypt data and decrypt their encrypted data when needed. Further, a system is needed that satisfies standards of cryptographic boundaries for cryptographic keys while also giving users the flexibility to maintain their own data on their own premises without needing to transmit their unencrypted data to a service provider for encryption and exposing the unencrypted data to attacks during transmission.

The inventor has discovered a novel method and system for cryptographic key management that guarantee compliance with acceptable data loss limits in the event a cryptographic key is forfeited or compromised. This novel method and system also satisfy the privacy and safety conditions of the cryptographic key usage such as the originator and the recipient cryptoperiod and as keys wear out from usage. This disclosure introduces a novel solution to cryptographic key management using a centralized management system that allocates collections of cryptographic keys with use limits to users based on a risk of data loss if the keys were compromised.

The novel methods and systems described herein introduce a new category of encryption keys, called Exportable Keys (EK), that are allocated to the users directly. EK keys are fully compliant with cryptographic keys management requirements. The methods and systems described herein balance an optimal number of EKs to issue to a user in order to comply with acceptable data loss limits while restraining overgrowth of the number of cryptographic keys being managed. By allocating a plurality of EKs to each user and tracking usage for each of the plurality of EKs, risk related to the encryption key loss is mitigated, as less data is encrypted by a given EK. The solution utilizes an envelope encryption technique to first encrypt a data object with a random cryptographic key, and then encrypting that random cryptographic key with an EK to generate an encrypted data envelope. Under this envelope encryption technique, a data object is first encrypted locally by a randomly generated cryptographic key and then a header of the encrypted data object is sealed, i.e., encrypted, with a an EK. Because a size of the header is known and is constant across data objects of different sizes, this envelope encryption technique enables accurate tracking of EK usage. Furthermore, a uniform usage of the EKs is achieved by selection of a random EK upon request from a user.

Throughout this disclosure and in the claims, reference to a level of data loss refers to a share of data which may be exposed to a third party in the event of the loss or compromise of a single cryptographic key. For example, when a single cryptographic key encrypts all data and the key is compromised, the level of data loss is 100%. If the data is encrypted evenly with 100 different keys and one key is compromised, then the level of data loss is only 1%.

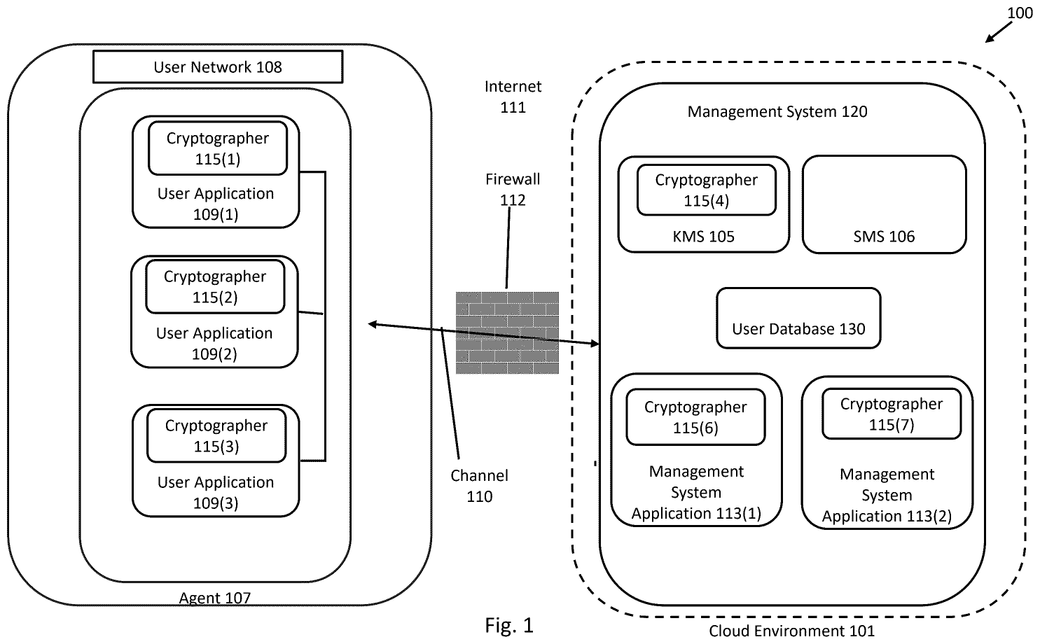

With reference to the figures, FIG. 1, illustrates a system 100. System 100 can include a management system 120 deployed in a cloud computing environment 101. Management system can further include a key management service (KMS) 105 and a secrets management service (SMS) 106. Management system 120 can include one or more management system applications 113, including but not limited to, one or more microservices, one or more tasks, and one or more jobs. Cryptographic computations, e.g., encryption and decryption, in management system 120 can be provided within the service boundary of KMS 105 by a cryptographer module 115 as well as locally within each respective application 113 by a respective local cryptographer module 115. Each cryptographer module described herein represents an instance of a cryptographer capable of performing cryptographic computations on plaintext data and ciphertext data and capable of generating cryptographic keys. Management system 120 can further include a user database 130 that stores data about one or more users of management system 120, including but not limited to, an acceptable level of data loss for each respective user, one or more master key usage policies that define usage limitations for versions of a master key of each respective user, and other information about the user.

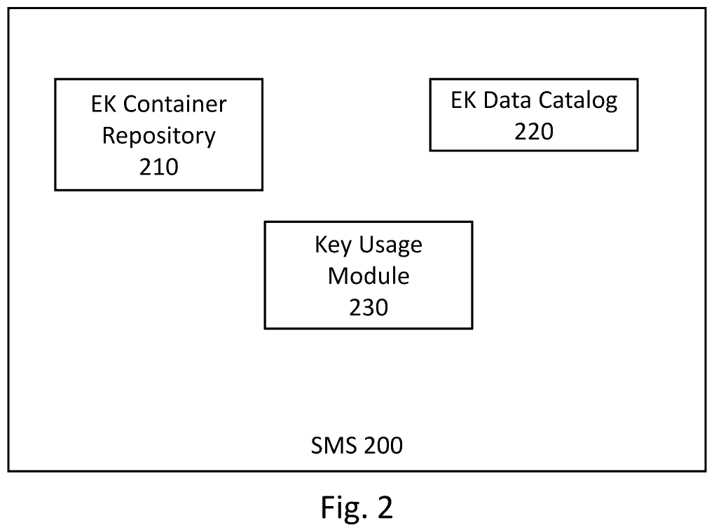

SMS 106 is responsible for storing existing exportable keys (EKs), managing the usage metrics of existing EKs, and determining whether to provide an existing EK to an application or to instruct an application to create a new exportable key (EK) to perform an encryption on a data object in response to an encryption request from the application to encrypt a data object. An exemplary SMS, e.g., SMS 200, is illustrated in FIG. 2. SMS 200 can include a EK container repository 210, a EK associated data catalog 220, and a key usage module 230. EK container repository 210 can be a relational database that stores existing EKs and a unique identifier for each existing EK (e.g., an EK ID). For example, EK container repository 210 can include entries that each comprise one or more exportable key containers and an identification of a respective EK contained in a corresponding exportable key container by a unique EK ID.

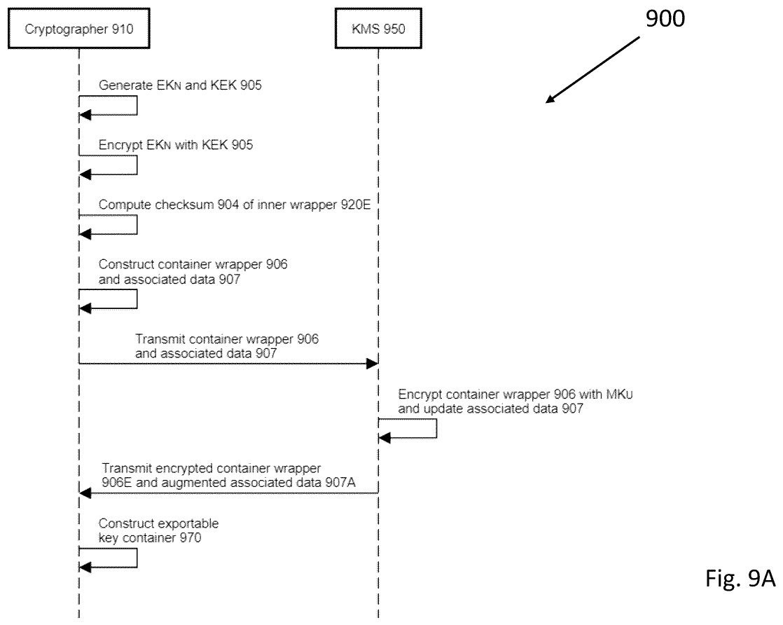

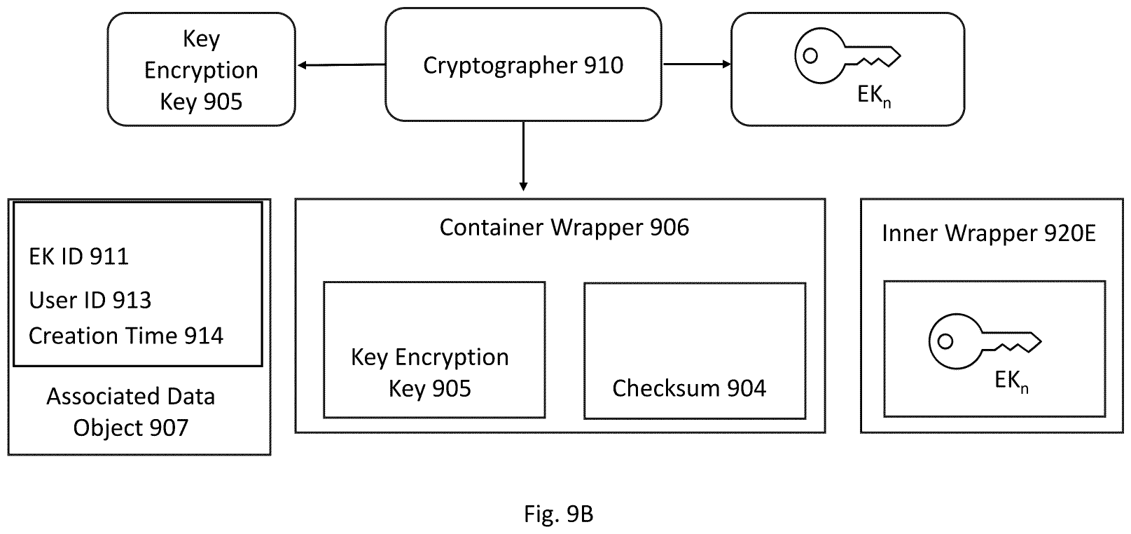

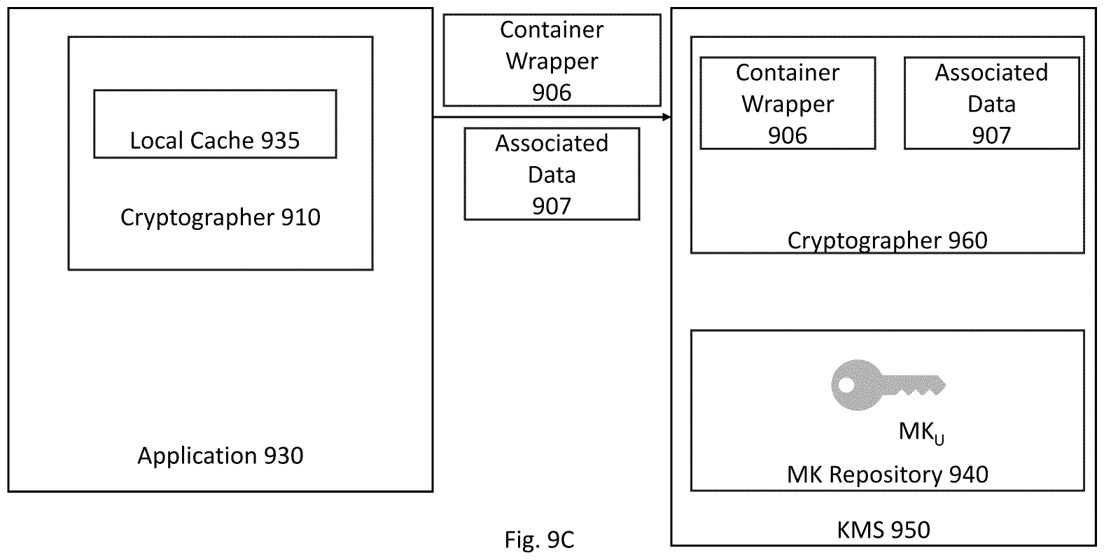

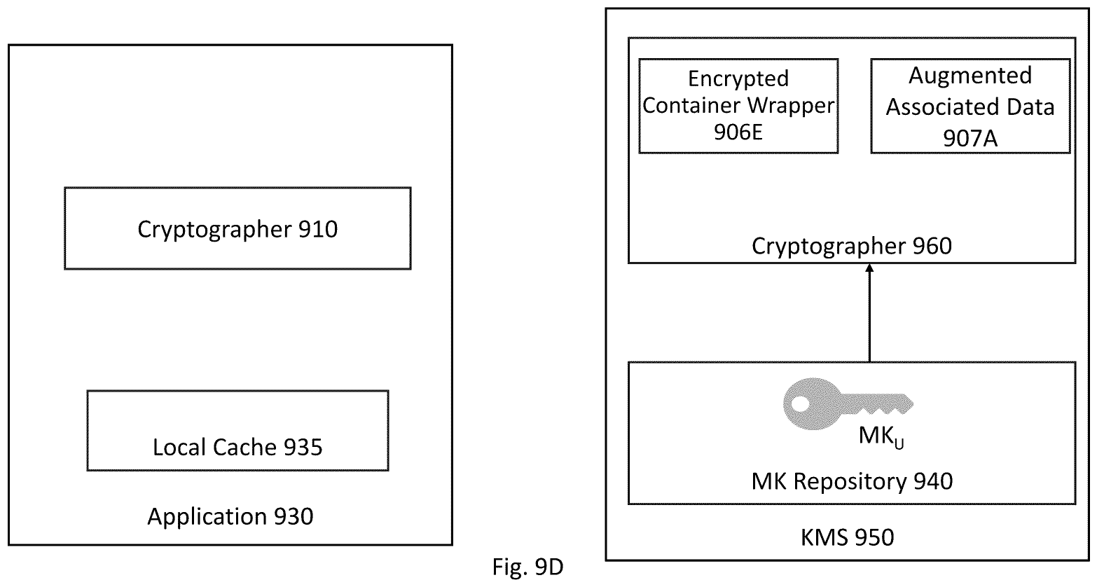

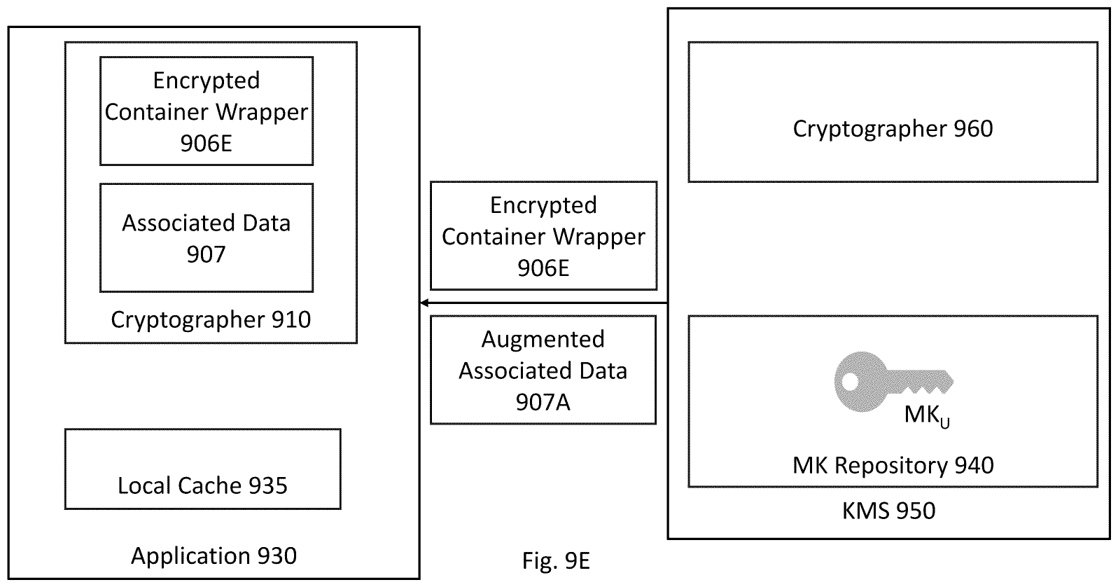

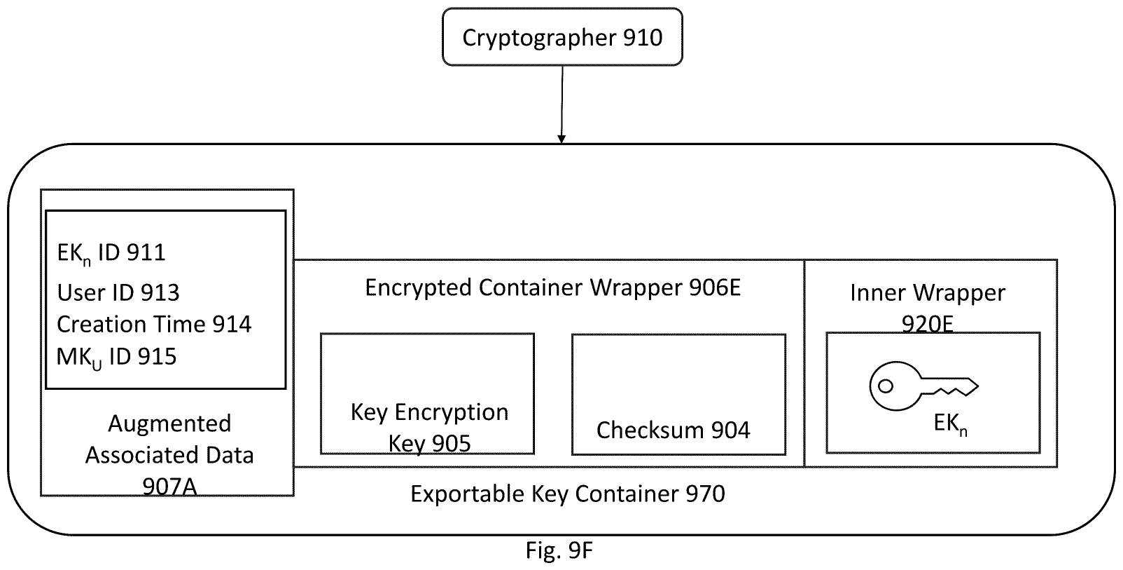

SMS 200 can optionally not have knowledge of the plaintext of the EKs stored in EK container repository 210. In such instances, SMS 200 can store an EK ID that identifies a particular EK without revealing information about the plaintext of the EK itself. Additionally or alternatively, SMS 200 can store an exportable key container, which is an encrypted data object that includes the EK encrypted with a different encryption key, referred to as a key encryption key (see, e.g., FIG. 9A-9F), rather than the plaintext of the EK itself. Thus, when SMS 200 transmits an EK to an application, or when SMS 200 receives an EK from an application, such as a user application 109 or a management system application 113, SMS 200 transmits/receives this encrypted exportable key container rather than the plaintext of the EK. This decreases the risk of compromise of the particular EK if the transmission is intercepted by a malicious actor because the malicious actor needs to decrypt the encryption key container and the EK that has been encrypted with the key encryption key in order to access the plaintext of the EK. The encrypted key container and process for generating it are discussed in further detail with reference to FIGS. 9A-9F.

EK data catalog 220 can be a relational database that stores a record of existing EKs and their usage metrics and associates the EKs and usage metrics with a corresponding user based on a unique user ID. As used throughout this disclosure, the term “usage metric” describes how much use a respective EK has had since being created. This usage metric can be provided as, for example, an integer value reflecting the total number of encryption operations the respective EK has been used for (e.g., 1 reflects 1 encryption operation, 2 reflects 2 encryption operations, etc.) or, inversely, an integer value reflecting the total number of encryption operations the respective EK has remaining in its lifetime (e.g., 1 reflects 1 encryption operation remaining, 2 reflects 2 encryption operations remaining, etc.). In the case of the latter, the lifetime of an EK can be defined by usage parameters and/or requirements intrinsic to the EK or by safe usage standards provided by the user and/or third party organizations that recommend usage standards. Additionally or alternatively, the usage metric can indicate a total amount of data that the respective EK has encrypted since being created or that the respective EK has left to encrypt in its lifetime. EK data catalog 220 can include entries that each comprise a unique EK ID for each existing EK, an indicator of the type of key the respective EK is (e.g., an encryption key, an HMAC key, etc.), a unique user ID of the user associated with the respective EK ID, one or more usage metrics of the respective EK, and a time of creation of the EK (e.g., a date and time when the EK was generated).

The usage metrics in EK data catalog 220 can be populated and updated based on usage reports provided by one or more applications associated with the corresponding user. SMS 106 can receive usage reports from one or more user applications 109 and/or management system applications 113 that indicate current usage metrics of one or more EKs used by the respective applications. These usage reports can be received periodically, such as every 15 minutes, or can be received when SMS 106 receives a request from an application to encrypt a data object. Alternatively, SMS 106 can fetch usage reports from one or more user applications 109 and/or management system applications 113 that indicate current usage metrics of one or more EKs used by the respective applications.

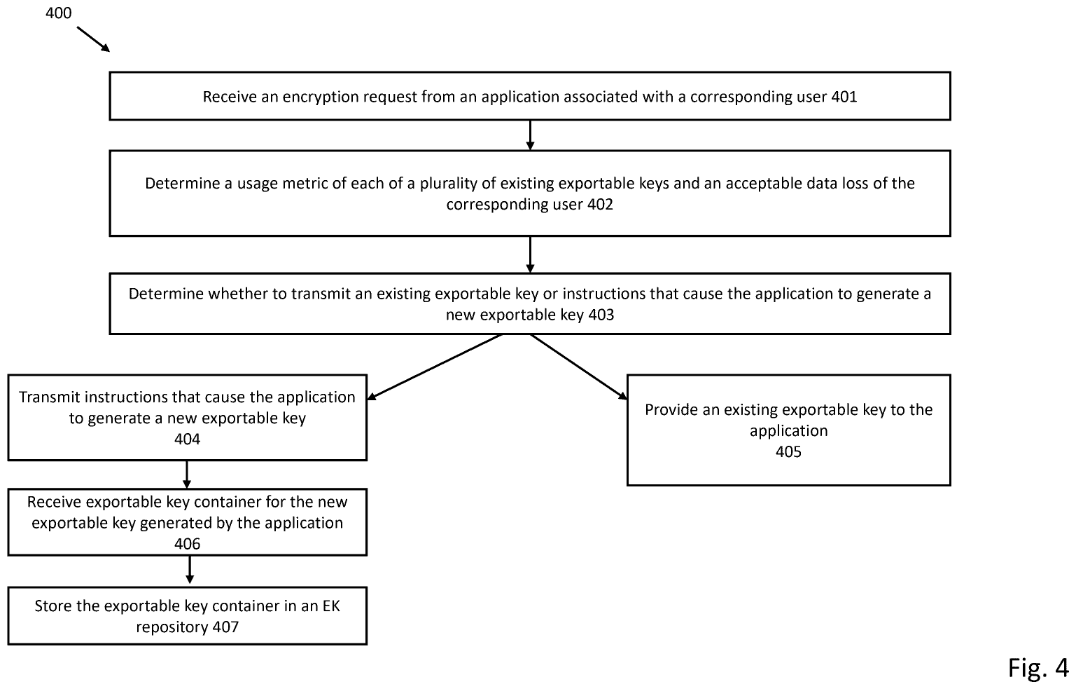

Key usage module 230 can determine whether an application, e.g., user application 109 or management system application 113, encrypting a data object using an existing EK may cause the acceptable level of data loss for a corresponding user associated with the application to be exceeded. Key usage module 230 analyzes the usage metrics stored in EK data catalog 220 and the acceptable level of data loss stored in user database 130 of management system 120 (see FIG. 1) for a given user to determine whether use of an existing EK by the application to encrypt a data object may cause the acceptable level of data loss to be exceeded. As discussed further with reference to step 403 of method 400 illustrated in FIG. 4, key usage module 230 applies a probabilistic model to determine a probability that an additional use of an existing EK by an application will cause the acceptable level of data loss of the corresponding user to be exceeded. If the probability of using an existing EK exceeds a threshold value, then SMS 200 instructs the application to generate a new EK locally and use that new EK to encrypt the data object, which decreases the likelihood of exceeding the acceptable level of data loss because an additional EK will be used. If the probability of using an existing EK is below a threshold value, then SMS 200 provides an existing EK to the application and instructs the application to use the existing EK to encrypt the data object. The acceptable level of data loss can be provided by the user. The acceptable level of data loss can also be a default value (e.g., 1%, 10%, etc.). The process for determining whether use of an existing EK to encrypt a data object may cause the acceptable level of data loss to be exceed is discussed in more detail with respect to exemplary method 400 illustrated in FIG. 4.

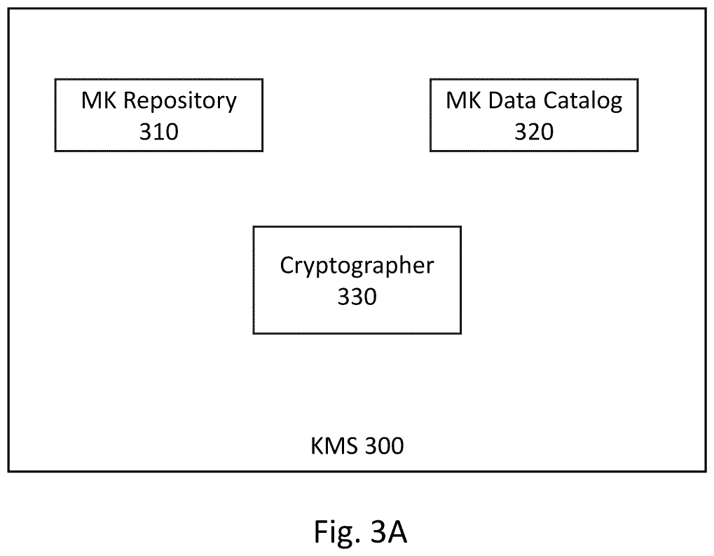

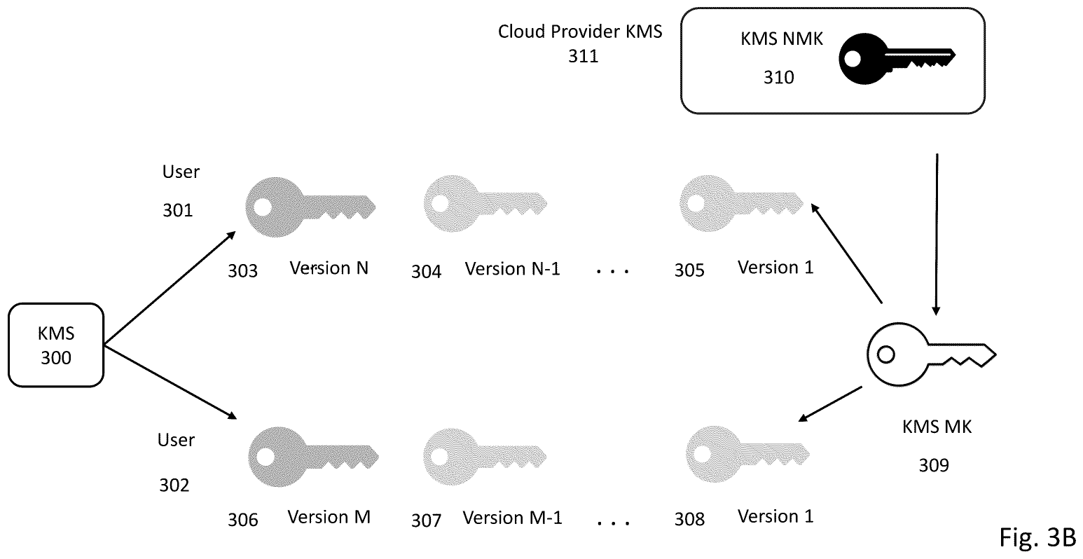

KMS 106 is responsible for storing one or more Master Keys (MKs) associated with one or more users and performing encryption operations using the one or more MKs, including encryption and decryption. An exemplary KMS, e.g., KMS 106 shown in FIG. 1, is illustrated in FIG. 3A. A KMS, e.g., KMS 300, can include an MK repository 310, MK data catalog 320, and cryptographer module 330. Similar to the EK container repository of the SMS, e.g., EK container repository 210 of SMS 200 in FIG. 2, MK repository 310 can be a relational database that stores existing MKs and a unique identifier for each MK (e.g., MK IDs). For example, MK repository 310 can include entries that each comprise the bits of an MK and an identification of the corresponding MK by a unique MK ID.

MK data catalog 320 can also be a relational database that includes data about the existing MKs stored in MK repository 310. For example, MK data catalog 320 can include entries that each comprise one or more of an identification of a respective MK by a unique MK ID, a unique user ID of the user associated with the respective MK, one or more usage metrics of the respective MK, and a time of creation of the MK (e.g., a date and time when the MK was generated).

Cryptographer module 330 is responsible for generating MKs and performing encryption operations, e.g., encryption and decryption, with the MKs. As shown in FIG. 3B, each user can have one or more versions of a master key, e.g., master keys 303, 304, and 305 allocated to user 301 and master keys 306, 307, and 308 allocated to user 302, used for encryption and decryption. KMS 300 can rotate use of the one or more master keys in a given set according to one or more MK usage policies associated with a user, which can be stored in user database 130. This can include a regular temporal rotation, such as every 6 months, upon expiration of a MK's cryptoperiod, upon key wear out due to a number of uses of the MK exceeding a threshold number of uses, or upon key wear out due the amount of data encrypted by the MK exceeding a threshold value. When a version of a master key reaches a usage limit established by an MK usage policy, cryptographer module 330 of KMS 300 can generate a new version of the MK and use the new version of the MK to perform encryption operations while retiring the previous version of the MK. For example, cryptographer module 330 can generate an MK 305 for a user 301. When MK 305 reaches its usage limit, cryptographer module 330 generates a new version of MK 305 as MK 304. Cryptographer module 330 then uses MK 304 to perform encryption actions and no longer uses MK 305. Each version of an MK, e.g., 303, 304, and 305, associated with a particular user, e.g., user 301, comprises bits that are different from the other versions of the MK associated with user 301. Similarly, each version of the MK associated with user 302, e.g., MK 306, 307, and 308, comprise bits that are different from one another. Each MK can be stored in MK repository in perpetuity and can be used for decrypting legacy data (i.e., previously encrypted data) of each user. As discussed in greater detail with respect to exemplary method 400 illustrated FIG. 4, MKs can be used by KMS 300 to encrypt a sealed data envelope and to encrypt an EK Container.

Each MK can be 256-bits long in order to be post-quantum cryptography resistant and suitable for use by AES-based algorithms. Each user's MKs can be persisted on a disk wrapped by a KMS Master Key 309, which can be used to encrypt each version of each user's MK, e.g., MK 303, 304, 305, 306, 307, and 308. KMS Master Key 309 can be, in turn, encrypted by a KMS Native Master key (NMK) 310 stored in a hosting Cloud Provider KMS 311. MKs never leave a boundary of KMS 300 unencrypted (i.e., MKs may leave the boundary of KMS 300 if encrypted). Because of this, MKs are not optimal for high-rate data encryption due to the latency of transmitting plaintext data that requires encryption by an MK from a user, e.g., user 301 or 302, to KMS 300 and sending the corresponding ciphertext back to the user.

As illustrated in FIG. 1, each application, e.g., a user application 109 and a management system application 113, includes a respective cryptographer module 115. Each cryptographer module 115 of applications 109 and 113 performs encryption and decryption operations on plaintext data and ciphertext data and communicates with KMS 105 and SMS 106. Each cryptographer module of application 109 and 113 can periodically transmit key usage reports to SMS 105 of management system 120. These key usage reports can identify each EK used by respective cryptographer modules 115 by their respective unique EK IDs and include information on a number of uses of each respective EK by cryptographer module 115 of the respective application 109 or 113 and/or a total volume of data encrypted by each respective EK. Upon receipt of these key usage reports, SMS can update the usage metrics for entries stored in EK data catalog 220 for the corresponding EKs identified in the key usage report by their unique EK IDs.

Further referring to FIG. 1, management system 120 can be in communication with a user network 108 via a channel 110 over a public network 111, such as the Internet. Specifically, channel 110 can connect management system 120 with an agent 107 located in user network 108. Agent 107 can be a module that executes one or more specialized user applications 109. Each user application 109 can correspond to a microservice, a task, or a job executing in agent 107 that communicates with management system 120 over channel 110. For example, a user application 109 can send an encryption request to encrypt or decrypt a data object to retrieve a cryptographic key to SMS 106. Similarly, a management system application 113 can send an encryption request to encrypt or decrypt a data object to SMS 106. When SMS 106 receives an encryption request from either a user application 109 or a management system application 113, SMS 106 can determine one or more usage metrics for existing exportable keys from EK data catalog 220, and key usage module 230 of SMS 106 can determine a probability that use of an existing EK to encrypt the data object will cause the acceptable level of data loss to be exceed for the corresponding user associated with the application. If the probability exceeds a threshold value, then SMS 106 can instruct the application to generate a new EK and use that new EK to encrypt the data object. If the probability does not exceed a threshold value, then SMS 106 can provide an existing EK to the application to encrypt the data object. Further, a user firewall 112 can reside at a boundary between user network 108 and Internet 111 through which channel 110 communicates.

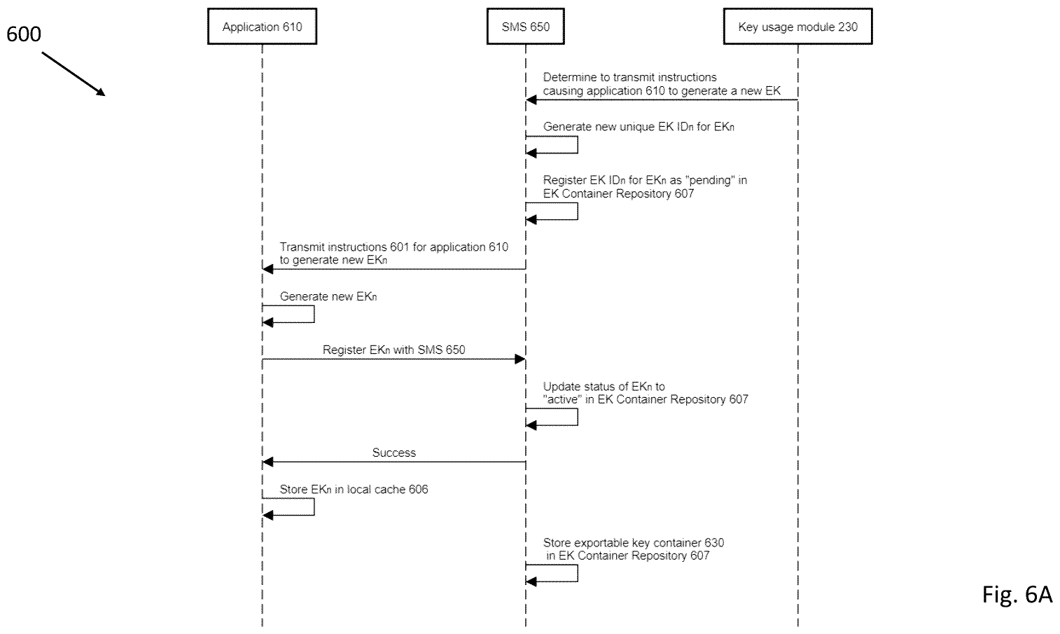

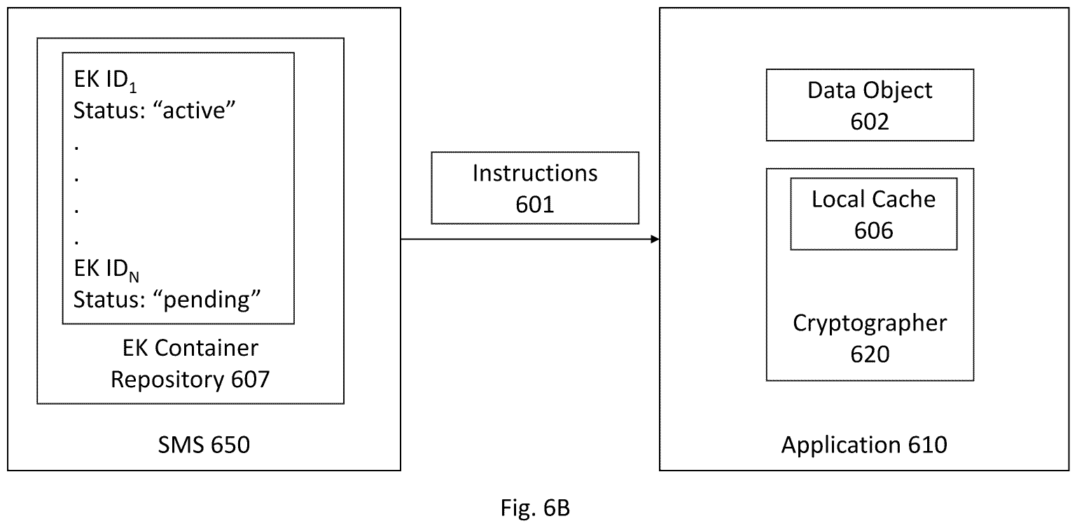

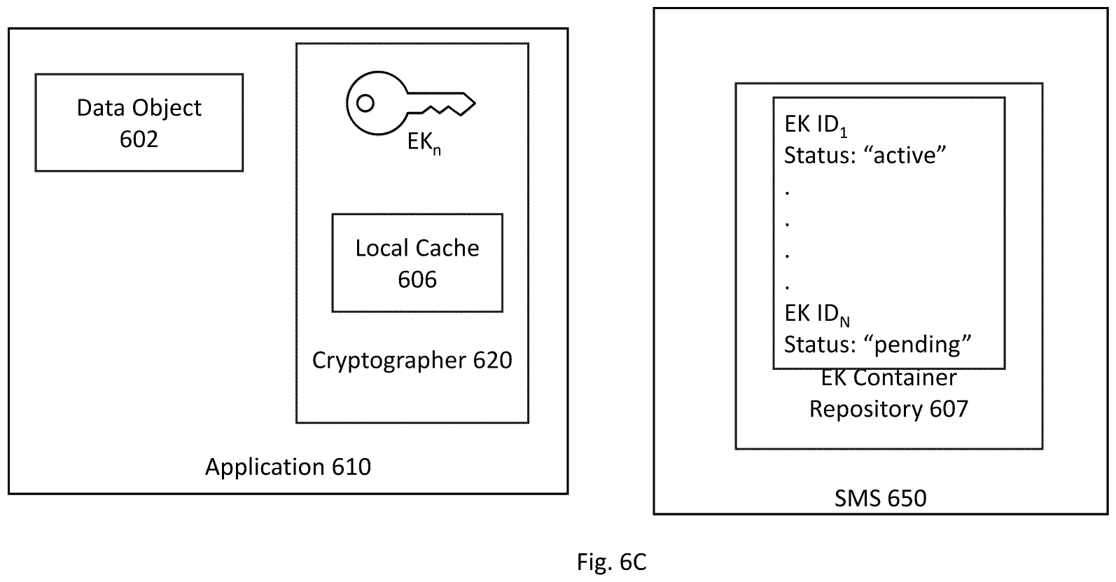

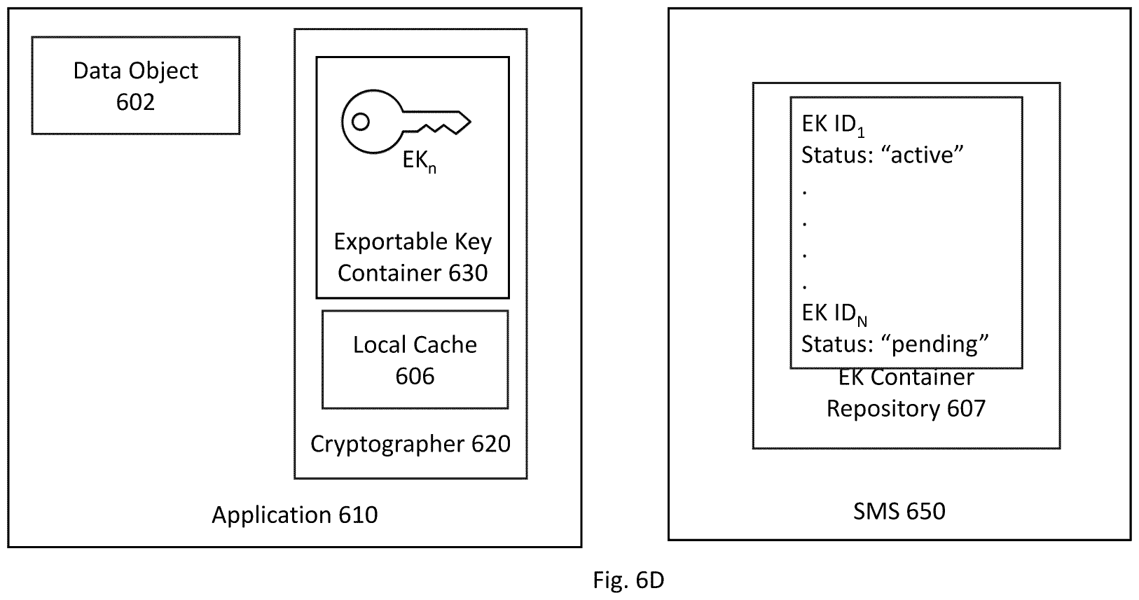

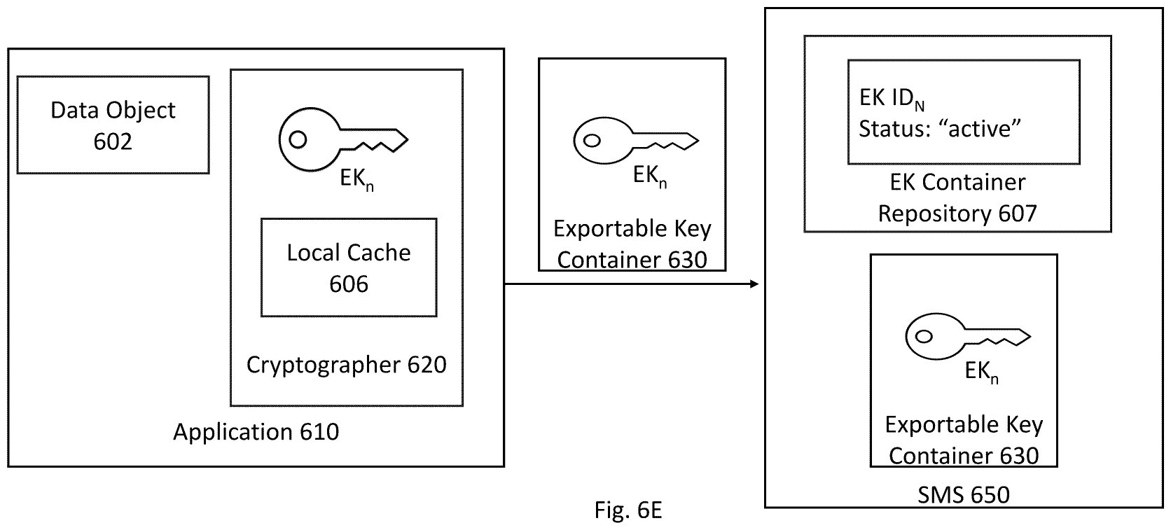

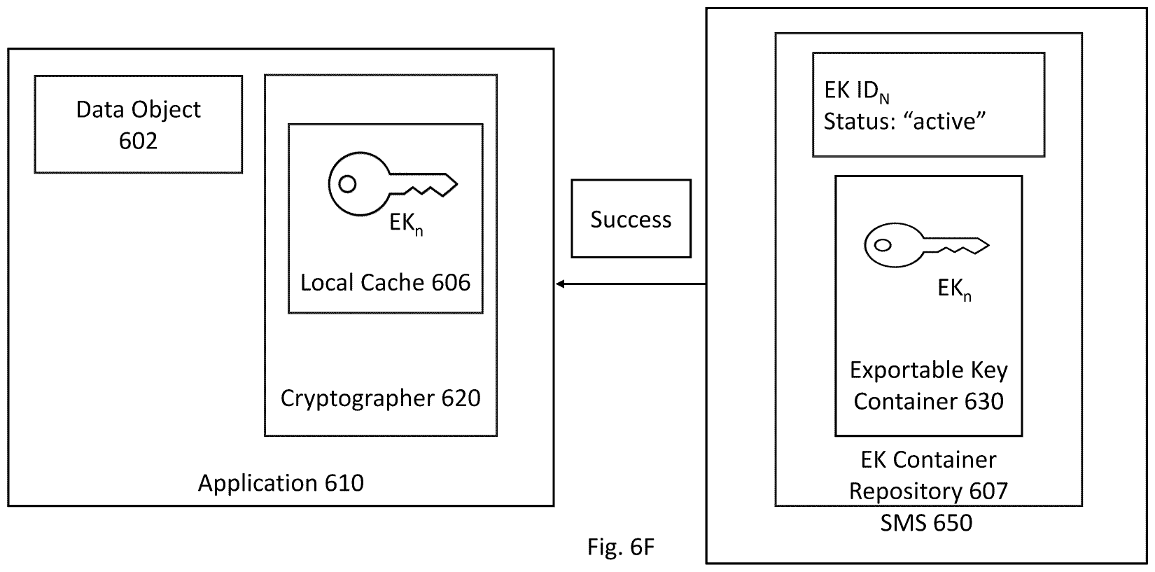

In addition, each cryptographer module 115 can include or be in communication with a local cache, respectively (see, e.g., FIGS. 6, 7, 8). Each local cache can store one or more encryption keys, e.g., EKs, for use in encryption and decryption of a data object by a respective cryptographer module 115.

An exemplary method for encrypting a data object according to this disclosure is provided with reference to the flowchart illustrated in FIG. 4. A method 400 can begin with step 401 of a management system receiving an encryption request from an application associated with a corresponding user, the encryption request including a request for an EK for the application to use to encrypt a data object. Next, the management system determines a usage metric of each of a plurality of existing exportable keys (EKs) associated with the corresponding user and an acceptable level of data loss of the corresponding user at step 402. Next, at step 403, the management system determines whether to transmit an existing EK to the application or to transmit instructions to the application that cause the application to generate a new EK based on a probability that using an existing EK will cause the acceptable level of data loss of the corresponding user to be exceeded. If the management system determines that the probability of exceeding the acceptable level of data loss by use of an existing EK associated with the corresponding user to encrypt the data object of the encryption request exceeds a threshold value in step 403, then the management system executes step 404 and transmits instructions to the application that cause the application to generate a new EK to use to encrypt the data object of the encryption request. These instructions can further cause the application to encrypt the data object using the new EK. If the management system determines that the probability of exceeding the acceptable level of data loss by use of an existing EK associated with the corresponding user to encrypt the data object of the encryption request does not exceed a threshold value in step 403, then the management system executes step 405 and transmits an existing EK associated with the corresponding user to the application to use to encrypt the data object of the encryption request. Executing step 405 can further include transmitting instructions that cause the application to encrypt the data object with the existing EK. After executing step 404, at step 406, the management system can receive an exportable key container corresponding to the new EK generated by the application based on the instructions transmitted by the management system in step 404. After receiving the exportable key container at step 406, the management system can execute step 407 and store the exportable key container in an EK container repository.

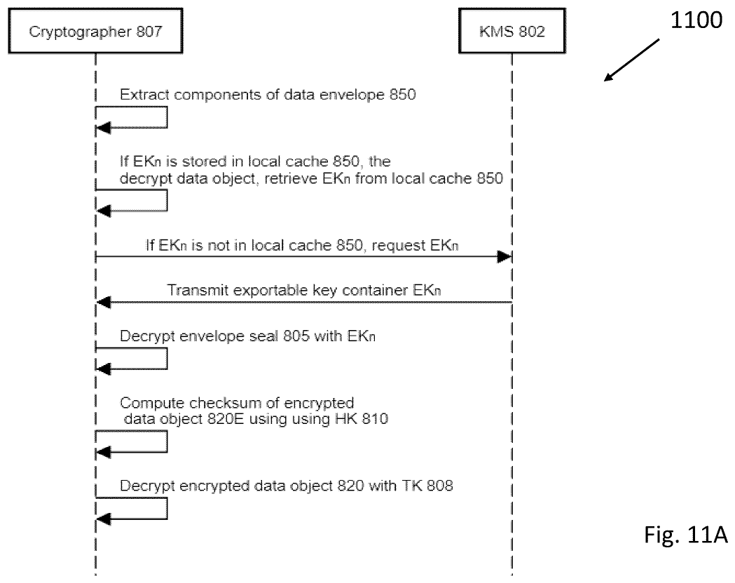

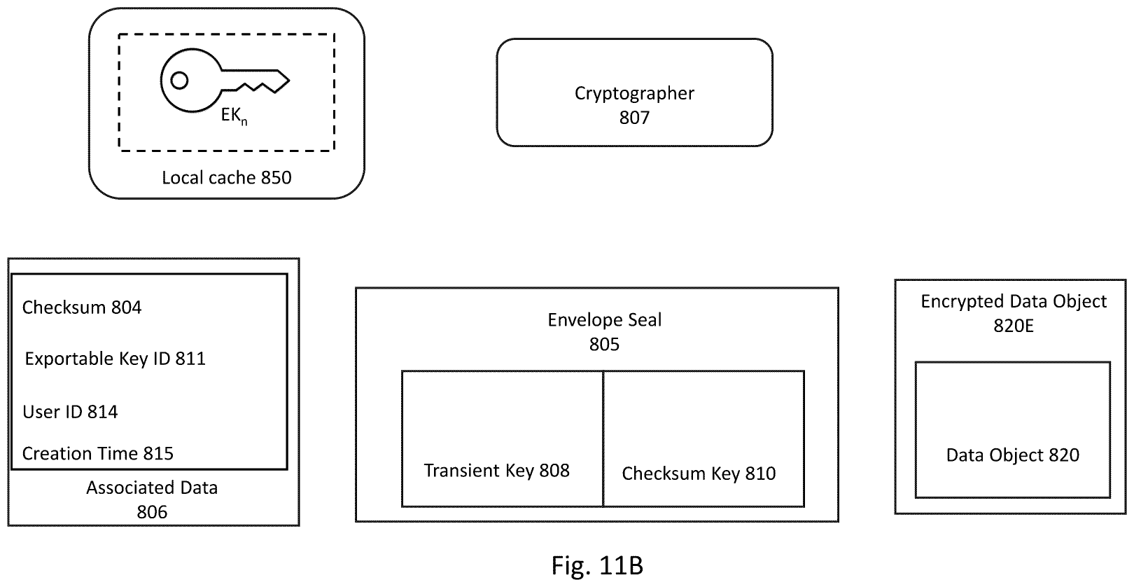

At step 401 of method 400, a management service receives an encryption request from an application. This can include SMS 106 of management system 120 shown in FIG. 1 receiving the encryption request from a user application 109 on agent 107 of user network 108 transmitted via channel 110. Alternatively, SMS 106 can receive an encryption request from a management system application 113. The encryption request can include a request for user application 109 or management system application 113 to encrypt a data object locally on the respective application with an EK associated with the user corresponding to the application. Alternatively, the encryption request can include a request for user application 109 or management system application 113 to decrypt an encrypted data object locally on the respective application. An exemplary method for decrypting an encrypted data object is described with reference to FIG. 11. The encryption request can include a user ID that serves as a unique identifier of a particular user associated with the requesting application, e.g., user application 109 or management system application 113. Further, the encryption request can include a usage report containing usage metrics for one or more EKs used by the respective application.

Prior to receiving an encryption request from an application, the cryptographer module can check a local cache of the application for an existing EK to use to encrypt a data object. This can include a cryptographer module of an application, e.g., cryptographer module 115 of a user application 109 or a management system application 113, checking a local cache for an EK to use to encrypt the data object. The local cache may be empty or otherwise not contain an existing EK. The local cache may be empty as a result of periodic purging by cryptographer module 115, which helps ensure that EKs are used uniformly and that no EKs are overused. Alternatively or additionally, cryptographer module 115 can transmit a key usage report to SMS 106 each time the local cache is purged. This helps ensure that SMS 106 has the most up to date usage metrics for all existing EKs associated with a particular user. If the local cache is empty, then cryptographer module 115 of the application transmits an encryption request to the management system, and method 400 begins with step 401 of the management system receiving that encryption request. If the local cache is not empty and contains an existing EK, then cryptographer module 115 can retrieve the bits of the EK from the local cache and use them to encrypt the data object. In such situations, cryptographer module 115 does not transmit an encryption request to the management system, and method 400 does not begin.

At step 402, the management system determines a usage metric of each of a plurality of existing EKs associated with the corresponding user and determines an acceptable data loss associated with the corresponding user. This can include SMS 106 parsing its EK container repository, e.g., EK container repository 210 in FIG. 2, for all existing EKs associated with the unique user ID of the corresponding user. SMS 106 can further parse a user database of the management system, e.g., user database 130, to determine an acceptable level of data loss associated with the unique user ID of the corresponding user. SMS 106 can further parse EK data catalog 220 for usage metrics of the existing EKs associated with the corresponding unique user ID of the user. SMS 106 can also request a usage report from the application to determine the usage metrics for existing EKs associated with the corresponding user.

Next, at step 403, the management system determines whether to transmit an existing EK to the application or to transmit instructions to the application that cause the application to generate a new EK. This can include a key usage module of the SMS, e.g., key usage module 230, of SMS 106 determining a probability that using an existing EK will cause the acceptable level of data loss of the corresponding user to be exceed, and thus whether the user should generate a new EK to encrypt the data object or whether the user should encrypt the data object with an existing EK to satisfy the encryption request. Key usage module 230 can determine a probability that use of an existing EK associated with the corresponding user to encrypt the data object will cause the acceptable level of data loss of the corresponding user to be exceed based on a probabilistic model, the usage metric for each existing EKs of the corresponding user, the acceptable level of data loss of the corresponding user, and the number of existing EKs already being used by the corresponding unique user ID of the user (as indicated by the usage metrics). Key usage module 230 can store and apply one or more of a plurality of probabilistic, analytic, or heuristic models that balance the total number of existing EKs for a corresponding user with the acceptable level of data loss of the corresponding user to ensure that the acceptable level of data loss is not exceeded by use of an existing EK for all existing EKs associated with the user.

If the probability determined by key usage module 230 exceeds a threshold value, then SMS 106 can proceed to step 404 and, based on the determination in step 403, transmit instructions to the application that cause the application to generate a new EK and use the new EK to encrypt the data object of the encryption request. If the probability determined by key usage module 230 does not exceed a threshold value, then SMS 106 can proceed to step 405 and, based on the determination in step 403, provide an existing EK to the application to use to encrypt the data object of the encryption request. The threshold probability value can be determined by the management system and dynamically changes each time key usage module 230 executes step 403 of method 400 based in part on the number of existing EKs already associated with a corresponding user and generation of a random number “r” uniformly distributed on the range of [0,1]. Thus, the probability threshold value can reflect a preference for generating new EKs if the threshold value is low, and can reflect a preference for using existing EKs if the threshold value is high.

As discussed earlier, the level of data loss is proportional to the portion of a total of data encrypted by each existing EK associated with a particular user. For example, if the user's data is evenly encrypted with 100 different keys (i.e., the amount of data encrypted per use is constant for all EKs and all EKs encrypt the same amount of data), the level of data loss is 1% in the event one key is compromised because each key encrypts 1% of the user's data. In this example, if a user's acceptable level of data loss is 1%, then using an existing EK to encrypt a data object of an encryption request will cause the level of data loss to exceed the user's acceptable level of 1% because at least one EK will have been used to encrypt more than 1% of the user's total encrypted data. In contrast, using a new EK to encrypt a data object of an encryption request will cause the level of data loss to fall below the user's acceptable level of 1% because no EK will be used to encrypt more than 1% of the user's total encrypted data.

Key usage module 230 can use a probabilistic model following a Gompertz function to determine whether the user generates a new EK to encrypt the data object or whether the user encrypts the encrypted data object with an existing EK to satisfy the encryption request. In general, a Gompertz function describes co-existence of at least two antagonistic processes with a coupling of their probabilities. In the context of this disclosure, these at least two antagonistic processes include the use of an existing EK and use of a new EK to encrypt a data object. The Gompertz function is a generalization of a sigmoid function which allows flexible control of a probability growth rate, in this context the overuse of existing EKs in violation of a user's acceptable level of data loss and the overproduction of EKs. Excessive use of existing exportable keys leads to increased risk of data loss caused by accelerated wear out of the existing exportable keys, greater volume of data encrypted by a given key in excess of an acceptable data loss level, and increased exposure to known ciphertext attacks. Overproduction of new EKs increases the cost and complexity of maintaining the EKs for use in additional encryptions of data objects and decryptions of encrypted data objects.

The Gompertz function used by key usage module 230 can take form of:

g(t)=ae^{be}^{^{ct}}

Parameter “a” of the Gompertz function represents the “g” coordinate asymptote, which can be interpreted as a maximum probability. Parameter “b” represents a sigmoid displacement factor, where a bias toward creating fewer new EKs increases as values of “b” increase. Parameter “c” represents a sigmoid growth rate, where a bias toward creating more new keys increases as values of “c” increase. And variable “t” represents a total number of existing EKs that have been generated already and are associated with the corresponding user. Key usage module 230 applying this Gompertz function can output a probability value “p” based on the inverse of the total number of existing EKs associated with the corresponding user and then generate a random number “r” uniformly distributed on the range [0,1]. If the value of “r” is greater than 1−p, then key usage module 230 determines that the user should encrypt the data object of the encryption request with a new EK and transmits instructions to the application that cause the application to generate a new EK. If the value of “r” is less than 1−p, then key usage module 230 determines that the user should encrypt the data object of the encryption request with an existing EK and transmits an existing EK to the application. Thus, when the total number of keys is low, the value of “p” will be higher, and there is a greater likelihood that “r” will be greater than 1−p and therefore a greater likelihood that key usage module 230 will determine that the application should encrypt the data object with a new EK. And when the total number of keys is high, the value of “p” will be lower, and there is a decreased likelihood that “r” will be greater than 1−p and therefore a greater likelihood that key usage module 230 will determine that the application should encrypt the data object with an existing EK.

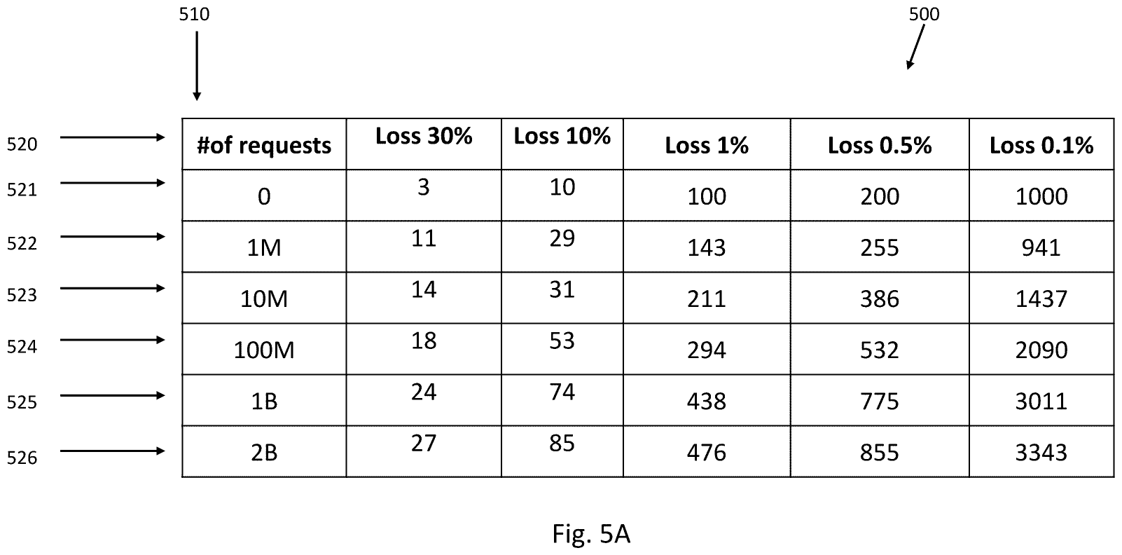

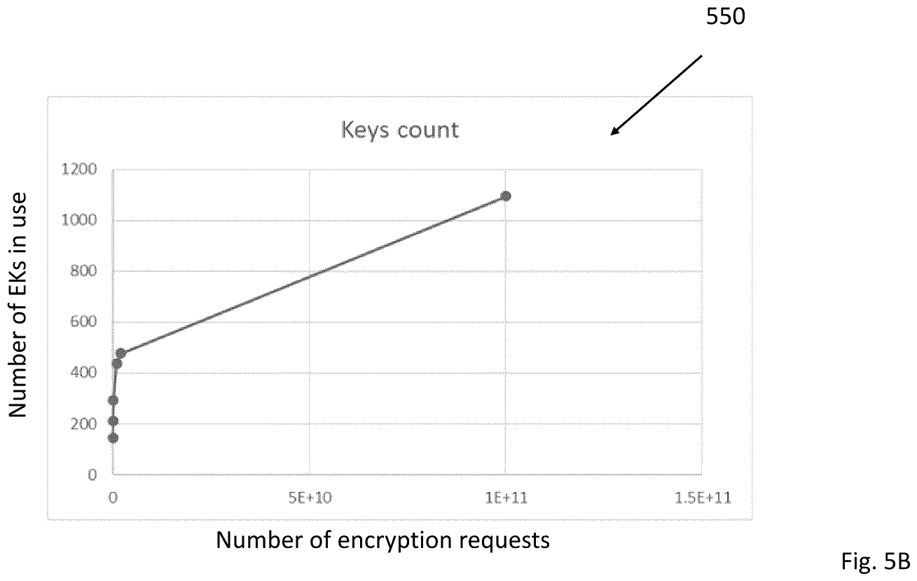

FIG. 5A illustrates an exemplary table 500 of a number of EKs used by a particular user applying the Gompertz function. Each column 510 of table 500 represents the number of EKs used by a user based on different acceptable levels of data loss provided in the left most column, and each of table 500 represents the number of EKs issued based on different numbers of requests for data encryption from a user provided in the upper most row 520. Row 521, which corresponds to O requests from the user, represents a minimum number of EKs needed to satisfy the user's acceptable level of data loss. For example, as illustrated in row 521 of table 500, if the user's acceptable level of data loss is 1%, then the minimum number of EKs needed to satisfy the user's acceptable level of data loss is 100, if the acceptable level of data loss is 0.5%, then the minimum number of EKs needed to satisfy the user's acceptable level of data loss is 200, and so on.

The remaining rows 522, 523, 524, 525, and 526 represent the number of exportable keys issued for a particular number of encryption requests, which also reflects a total number of uses of all keys associated with the user where each encryption request encrypts the same amount of data, at each exemplary acceptable level of data loss as determined by applying the Gompertz function. For example, given a number of encryption requests of 1 million, e.g., row 522, a total of 143 EKs have been generated and used to encrypt the user data in those requests when an acceptable level of data loss is 1%, a total of 255 EKs have been generated and used to encrypt the user data in those requests when an acceptable level of data loss is 0.5%, and so on. It will be appreciated that the exemplary number of EKs illustrated in row 521 is conservative. Since the number of EKs grows over time, it is possible to assign initially a smaller number of keys and still satisfy the maximal data loss threshold desired by the user (as illustrated by chart 550 in FIG. 5B).

Use of the Gompertz probability distribution facilitates creation of multiple keys during an initial interval of operation, this creation slowing down as the number of EKs being used increases to become sub-logarithmic overtime. FIG. 5B illustrates a chart 550 of a number of EKs issued per number of encryption requests where an acceptable level of data loss is 1%. As chart 550 illustrates, the rate of EK generation per encryption request has sub-logarithmic characteristics, with the rate of generation being greater for a smaller number of EKs and decreasing as the number of EKs increases. This behavior is the result of satisfying the acceptable level of data loss of the user. During an initial period of EK usage, each EK will encrypt a larger portion of the user's encrypted data until the threshold number of EKs required to satisfy the acceptable level of data loss is met (i.e., as illustrated in row 521 of FIG. 5A). This initial period corresponds to higher values of “p” because there are a lower number of existing EKs, and a preference for generating new EKs is reflected. As illustrated in chart 550, for the acceptable level of data loss of 1% to be reached, key management system 120 first receives a total of 540 encryption requests from a user and instructs the user to generate 100 exportable keys based on the usage metrics of EKs being used, the total number of EKs being used at the time of each encryption requests, and the acceptable level of data loss for the user. After this acceptable level of data loss is reached, the rate of EK generation slows, as existing EKs can be used to satisfy subsequent encryption requests while maintaining an acceptable level of data loss at or below the acceptable level of 1%. This period of slowing down corresponds to lower values of “p” because there are a higher number of existing EKs which can be used to satisfy encryption requests without exceeding the user's acceptable level of data loss.

It will be appreciated that functions other than the Gompertz function, such as the sigmoid function and the hyperbolic tangent function, can be used without departing from the scope of this disclosure. It is appreciated that in an exemplary implementation of this invention, parameters of the function can be adjusted dynamically in order to satisfy the user's acceptable level of data loss. It will also be appreciated that key usage module 230 can be modeled as a single neural network with a trainable activation function in the form of a Gompertz function subject to uniform inputs.

Returning to FIG. 4, if the management system determines that the probability of exceeding the acceptable level of data loss for the corresponding user exceeds a threshold value by using an existing EK associated with the corresponding user to encrypt the data object of the encryption request in step 403, then the management system executes step 404 and transmits instructions to the application that cause the application to generate a new EK to use to encrypt the data object of the encryption request. Executing step 404 can include SMS 106 transmitting instructions to application 109 or 113 that cause cryptographer module 115 of application 109 or 113 to generate a new EK to use to encrypt the data object. An exemplary method of executing step 404 and transmitting instructions that cause the application to generate a new EK is described with respect to FIGS. 6A-6F.

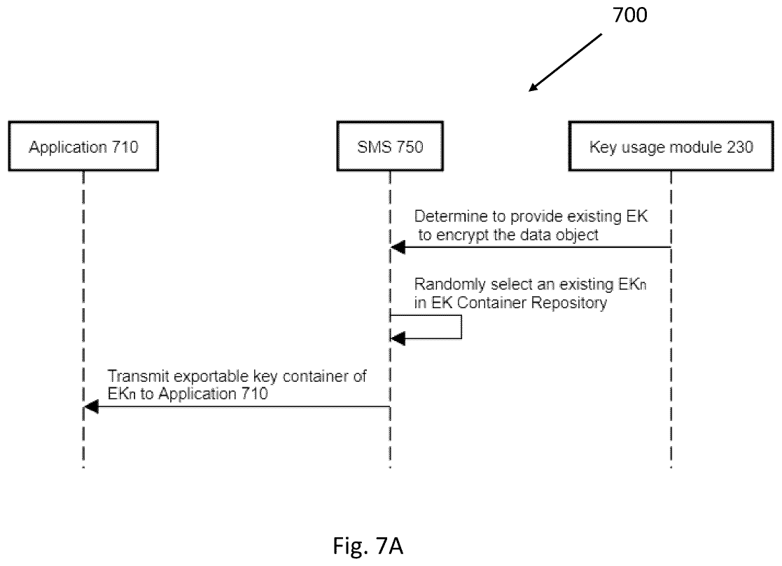

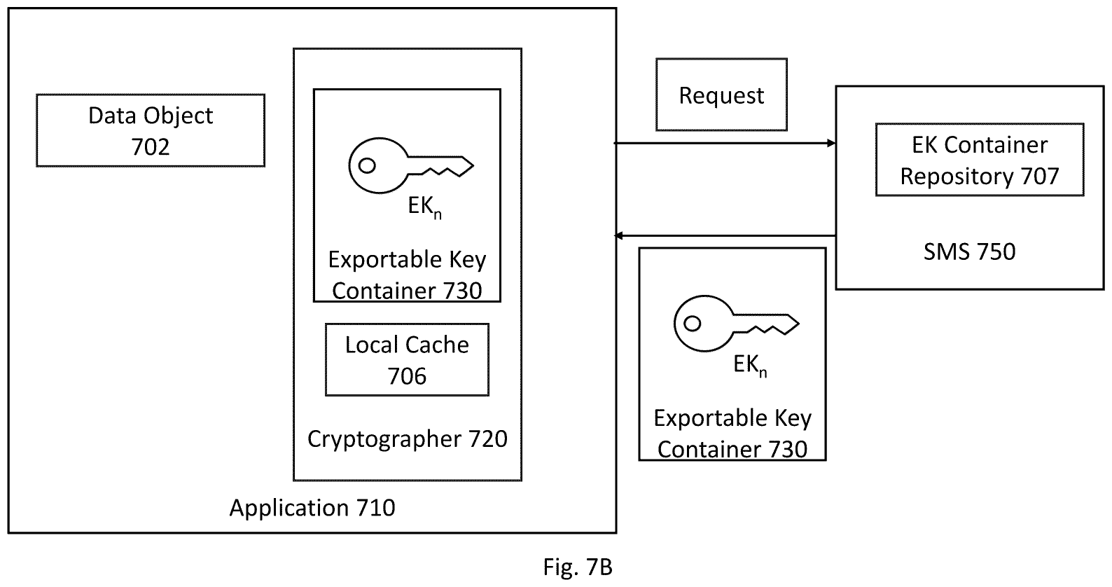

If the management system determines that the probability of exceeding the acceptable level of data loss for the corresponding user does not exceed a threshold value by using an existing EK associated with the corresponding user to encrypt the data object of the encryption request in step 403, then the management system executes step 405 and transmits an existing EK associated with the corresponding user to the application to use to encrypt the data object of the encryption request. Executing step 405 can include SMS 106 retrieving an existing EK container from an EK container repository, e.g., EK container repository 210 in FIG. 2, and transmitting the existing EK container to the user application, e.g., user application 109 or management system application 113, for cryptographer module 115 of application 109 or 113 to encrypt the data object using the existing EK. Executing step 405 can further include SMS 106 transmitting instructions that cause the application to encrypt the data object using the existing EK provided by SMS 106. An exemplary method of executing step 405 for transmitting an existing EK container associated with the corresponding user to the application to use to encrypt the data object of the encryption request is described with respect to FIGS. 7A-7B.

After executing step 404, the management system can execute step 406 and receive an exportable key container for the new EK generated by the application. As illustrated in FIG. 6E, this can include an SMS 650, e.g., SMS 106 shown in FIG. 1, receiving an exportable key container 630 from a cryptographer module 620 of application 610, e.g., user application 109 or management system application 113 shown in FIG. 1. Lastly, upon receipt of the exportable key container, the management system can execute step 407 and store the exportable key container in an EK container repository. As illustrated in FIG. 6F, this can include SMS 650 storing exportable key container 630 in EK container repository 607.

An exemplary method for transmitting instructions that cause an application to generate a new EK (i.e., step 404 of method 400) is illustrated in FIGS. 6A-6I. The flowchart in FIG. 6A begins with a key usage module, e.g., key usage module 230 of FIG. 2, determining to transmit instructions that cause the user application to generate a new EK and encrypt the data object of the encryption request with the new EK (e.g., step 403 of method 400 show in FIG. 4). Next, method 600 for transmitting instructions that cause an application to generate a new EK begins with an SMS, e.g., SMS 650, generating a new unique EK ID for the new EK. As illustrated in FIG. 6B, this can include SMS 650 generating a unique EK IDₙ for a new EKₙ and storing EK IDₙ in EK container repository 607. Next, SMS 650 can register EKₙ as “pending.” This can include SMS 650 recording a status indicator corresponding to EK IDₙ in EK container repository 607 as “pending.” Next, SMS 650 transmits instructions 601 to application 610 that cause application 610 to generate a new EK. This can include SMS 650 transmitting instructions 601 to application 610, which can be a user application, e.g., user application 109, or a management system application, e.g., management system application 113. Instructions 601 can include the unique EK IDₙ generated by SMS 650. Providing a unique EK ID for each EK helps SMS 650 track the number of EKs generated for a given user, and registering the state of the EK helps further track the status of EKs for a particular user.

Next, instructions 601 cause application 610 to generate a new EK. As illustrated in FIG. 6C, this can include a cryptographer module, e.g., cryptographer module 620 generating a new EKₙ. The new EKₙ can be generated as a random cryptographic key that can be used with known symmetric encryption algorithms, including but not limited to AES. EKₙ can be generated using a secure random number generator, such as but not limited to a DRBG (deterministic random bit generator), or by a standard symmetric key generation algorithm, such as but not limited to a KBKDF (key-based key derivation function) algorithm. Instructions 601 can further cause application 610 to generate a corresponding Key Encryption Key (KEK) (see, e.g., FIGS. 9A-9F). This can include cryptographer module 620 generating a second random cryptographic key that can be used with known symmetric encryption methods, including but not limited to AES. KEK can be generated using a secure random number generator, such as but not limited to, a DRBG, or by a standard symmetric key generation algorithm, such as but not limited to, a KBKDF algorithm.

Next, instructions 601 cause application 610 to register the new EKₙ with SMS 650. As illustrated in FIGS. 6D and 6E, this can include cryptographer module 620 of application 610 generating an exportable key container 630 for EKₙ and transmitting exportable key container 630 to SMS 650. As discussed in further detail with respect to FIGS. 2 and 9, an exportable key container describes an encrypted data object that contains, at least in part, the plaintext of EKₙ encrypted with the KEK generated by cryptographer module 620. Transmitting exportable key container 630 rather than the plaintext of EKₙ eliminates the risk of EK, being compromised while being transmitted from application 610 to SMS 650 by cryptographer module 620 because KEKₙ is required to access EKₙ from exportable key container 630.

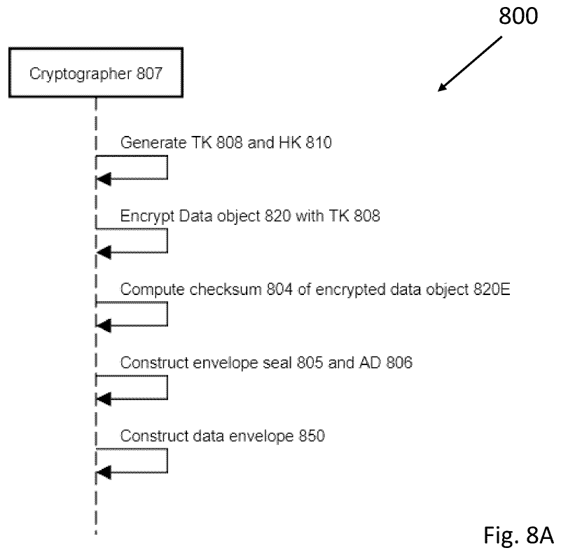

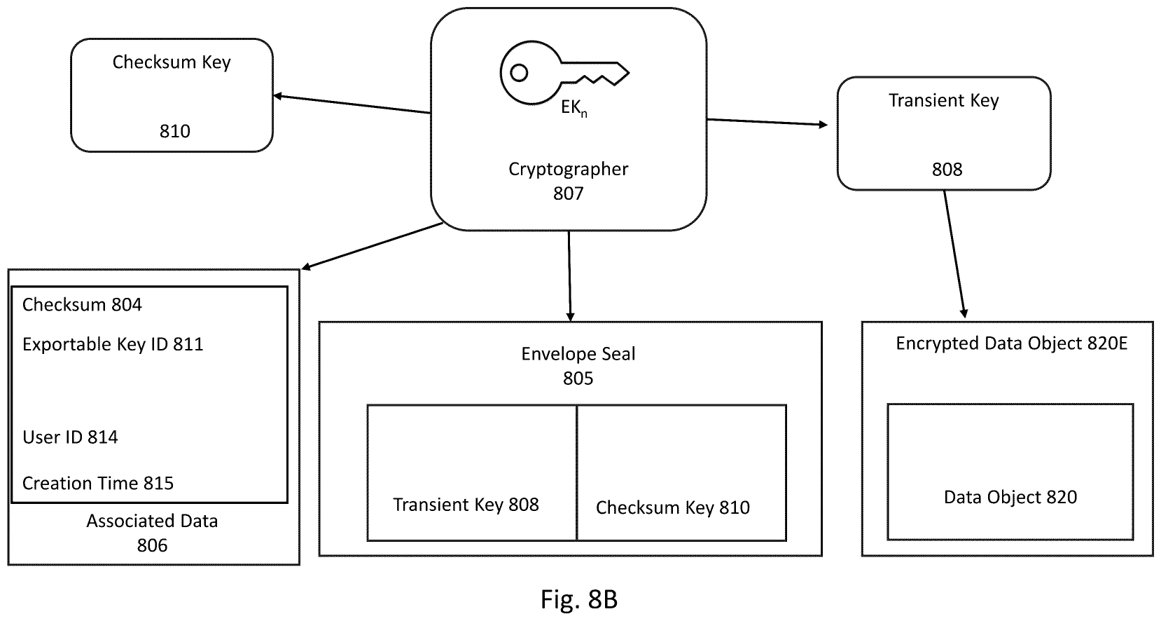

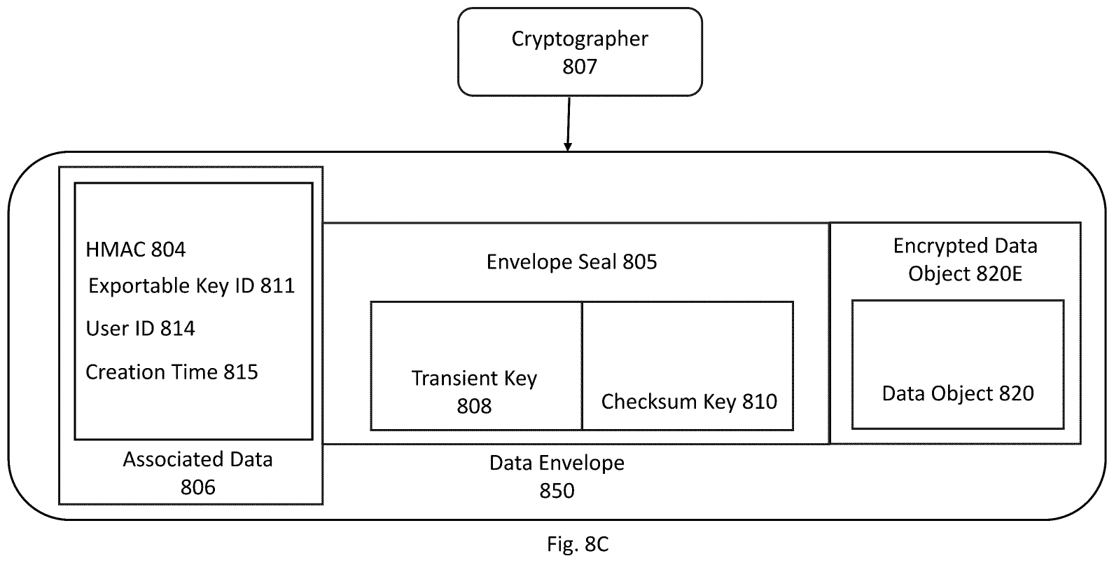

Upon receipt of exportable key container 630, SMS 650 compares the EK ID indicated by exportable key container 630 with the corresponding “pending” entry for EK IDₙ in EK container repository 607. If the EK IDs match, then SMS 650 can update the status of the entry corresponding to EK IDₙ for EKₙ as “active” to indicate that EKₙ has been generated by application 610. SMS 650 can then return a success message to application 610 indicating that EKₙ has been registered with SMS 650, as illustrated in FIG. 6F. When SMS 650 returns a success message to cryptographer module 620, cryptographer module 620 can store EKₙ locally. This can include cryptographer module 620 storing the bits corresponding to EKₙ in local cache 606. Cryptographer module 620 can then proceed to encrypt the data object using EKₙ. An exemplary method for encrypting a data object using an EKₙ is described with reference to FIGS. 8A-8C.

If the EK IDs do not match, then SMS 650 returns an error message to cryptographer module 620 indicating that the EK ID of exportable key container 630 does not match any EK ID in EK container repository 607. In such scenarios, SMS 650 discards the “pending” entry in EK container repository 607, forcing cryptographer module 620 to transmit another encryption request to the management system.

An exemplary method for providing an existing EK to an application to encrypt a data object using existing EK (i.e., step 405 of method 400) is illustrated in FIGS. 7A-7B. FIG. 7A illustrates a flowchart that begins with a key usage module, e.g., key usage module 230 illustrated in FIG. 2, determining to provide an existing EK to the application based on the determination that the probability of exceeding the acceptable level of data loss of the corresponding user by encrypting the data object with an existing EK is below a threshold value (e.g., step 403 of method 400 shown in FIG. 4). Next, SMS 750 begins executing step 405 of method 400 and selects an existing EK in the EK container repository, e.g., EK container repository 707 shown in FIG. 7B, to provide to the cryptographer module of the application to use to encrypt the data object. SMS 750 may select a random existing EK, for application 710, e.g., a user application 109 or a management service application 113 in FIG. 1, for cryptography 720, e.g., a cryptographer module 115 in FIG. 1, to use to encrypt the data object, e.g., data object 702 in FIG. 7B. This can include SMS 750 parsing EK container repository 707 for entries of a user ID matching the user ID indicated in the encryption request received by the SMS in step 401 of method 400. Once SMS 750 identifies all entries in EK container repository 707 matching the unique user ID, SMS 750 can randomly select EKₙ of one of those entries. Randomly selecting an existing EK helps ensure uniform usage of all existing EKs by the applications associated with the user so that the acceptable level of data loss is not exceeded.

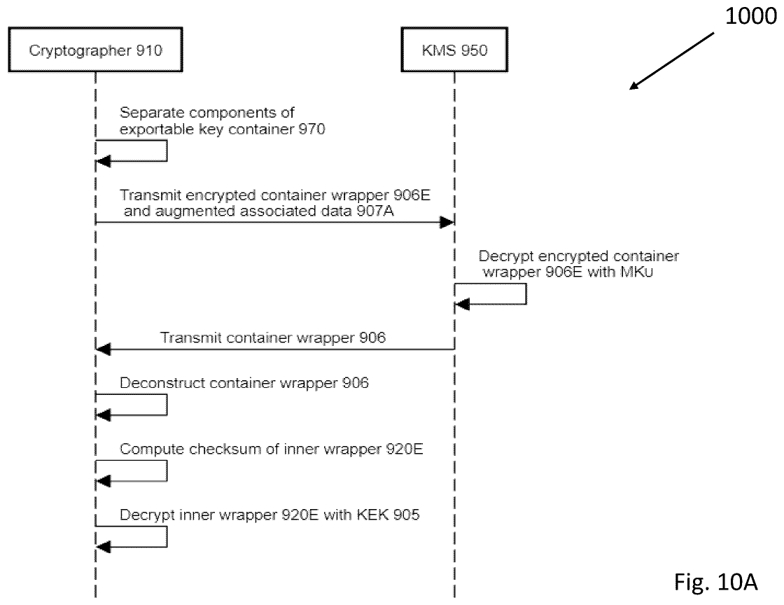

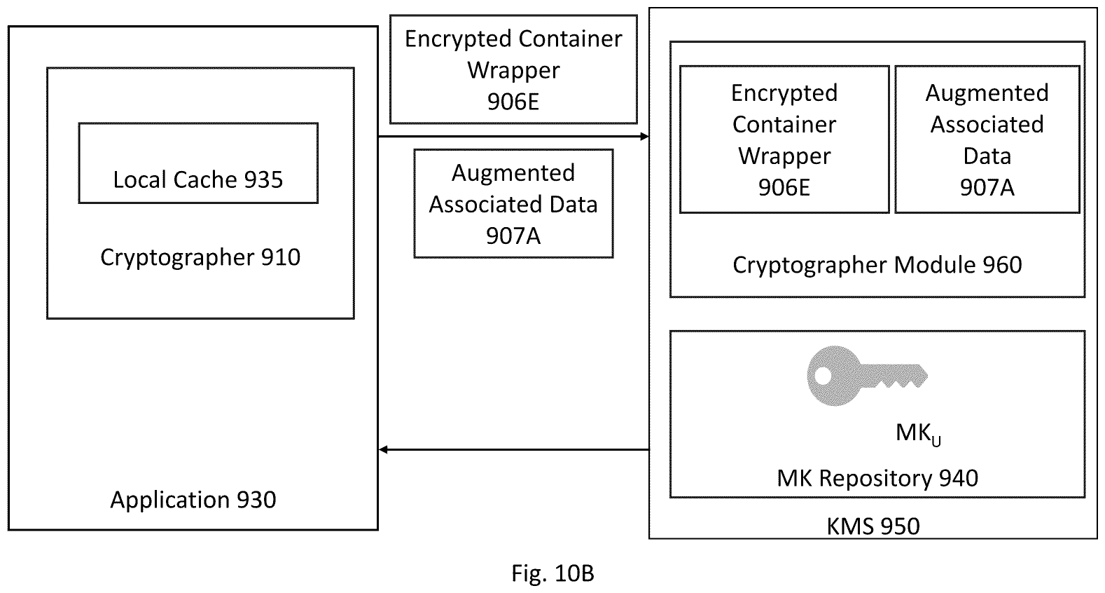

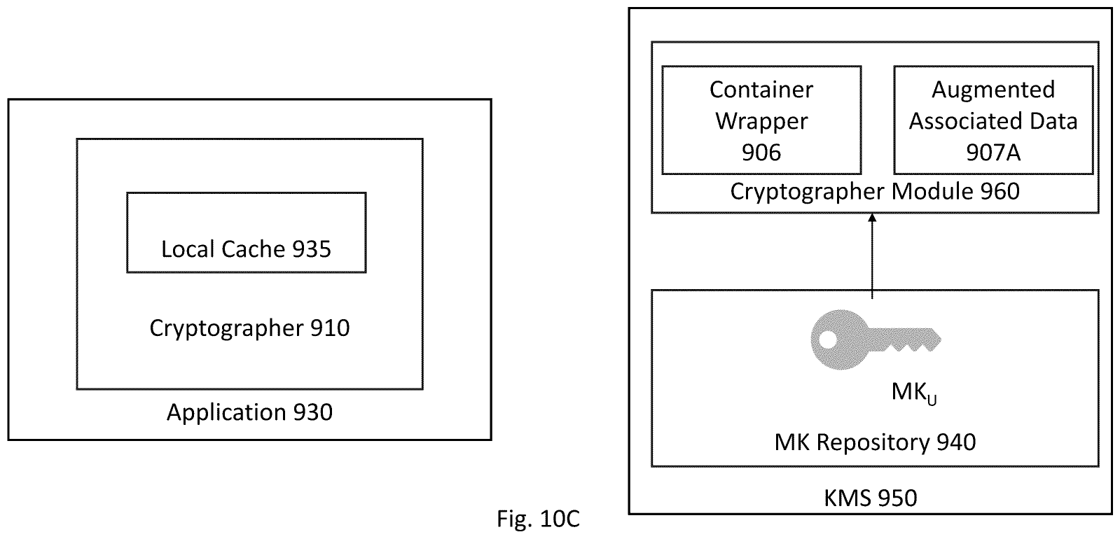

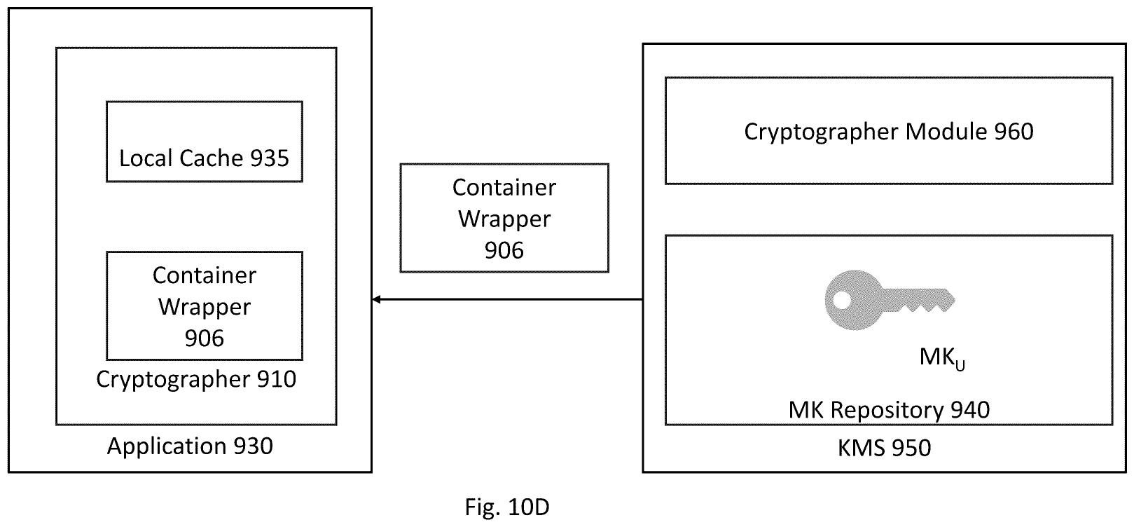

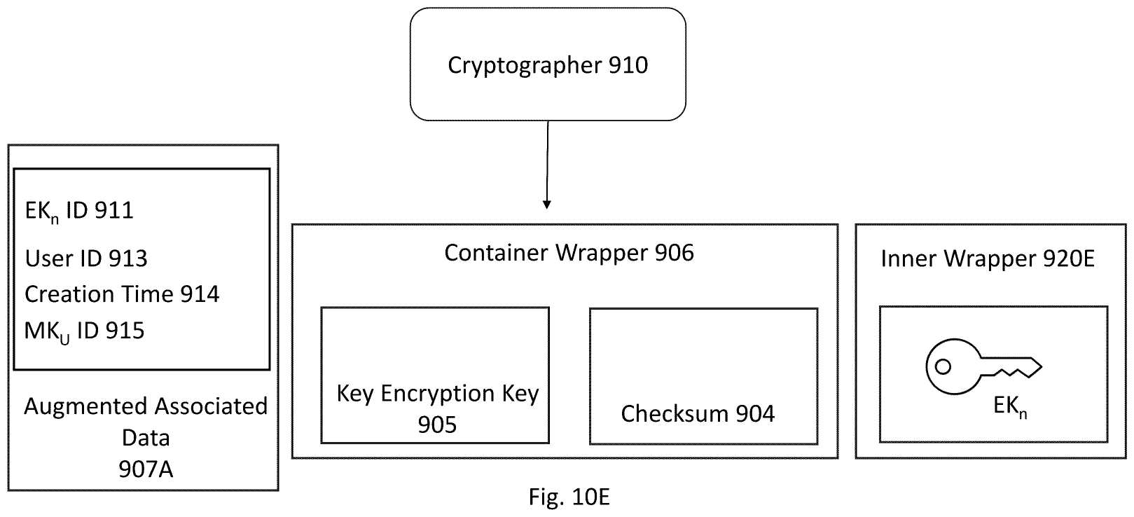

Once SMS 750 selects an existing EKₙ, SMS 750 transmits an exportable key container corresponding to EKₙ to cryptographer module 720 to use EKₙ to encrypt the data object. As illustrated in FIG. 7B, this can include SMS 750 retrieving an exportable key container, e.g., exportable key container 730, from key containers repository 707 matching the unique EK ID of EKₙ selected by SMS 750 and transmitting exportable key container 730 to application 710. Transmitting EKₙ can further include transmitting instructions to application 710 that cause application 710 to encrypt the data object using the existing EK, selected by SMS 750. Cryptographer module 720 of application 710 can then access the plaintext of EKₙ from exportable key container 730 to encrypt the data object with EKₙ according to the exemplary method for extracting an EK from an exportable key container discussed with reference to FIG. 10. Once cryptographer module 720 of application 710 has access to the plaintext of EKₙ, it proceeds to encrypt the data object, as illustrated in and discussed with reference to FIGS. 8A-8C.

An exemplary method for encrypting a data object using a EK is described with respect to FIGS. 8A-8C. A method 800 begins with a cryptographer module of an application, e.g., a user application 109 or a service management application 113, generating two cryptographic keys, a transient key (TK) and a checksum key (HK). As illustrated in FIG. 8B, a cryptographer module 807 of an application 801 can generate each of a TK 808 and a HK 810 using a secure random number generator, such as but not limited to a DRBG, or by a standard symmetric key generation algorithm, such as but not limited to a KBKDF algorithm. Next, application 801 encrypts data object 820. This can include cryptographer module 807 using TK 808 to encrypt the plaintext payload of data object 820 to create an encrypted data object 820E. Cryptographer module 807 can encrypt data object 820E according to a standard encryption method, such as, and without limitation, an AES-GCM (Galois Counter) block cipher encryption mode, AES-CBC (Cipher Block Chaining) block cipher encryption mode, or a stream cipher encryption mode. Next, application 801 computes an HMAC 804 of encrypted data object 820E. This can include cryptographer module 807 generating a cryptographic checksum (HMAC) 804 of encrypted data object 820E using HK 810 according to a cryptographic hash function, including but not limited to, hash functions in the SHA-2 or SHA-3 families of hash functions.

Next, application 801 constructs an envelope seal 805. This can include cryptographer module 807 concatenating TK 808 and HK 810 together according to TK|HK and then encrypting TK|HK using an exportable key, e.g., EKₙ. Cryptographer module 807 can use an authenticated encryption with associated data (AEAD) encryption method to construct envelope seal 805. Next, application 801 can generate an associated data object (AD) 806. This can include cryptographer module 807 generating metadata associated with envelope seal 805 and the user associated with application 801, including but not limited to, a checksum 804 of the encrypted data object 820E, an EK ID 811 corresponding to EKₙ (e.g., EK IDₙ), a unique user ID 814 corresponding to the user associated with application 801, and a creation time 815 corresponding to the time at which envelope seal 805 is constructed by cryptographer module 807 of application 801. Lastly, cryptographer module 807 concatenates associated data 806, encrypted envelope seal 805, and encrypted data object 820E according to “associated data 806”|“encrypted envelope seal 805”|“encrypted data object 820E” to construct a data envelope 850 illustrated in FIG. 8C.

As discussed throughout this disclosure, an EK can be itself encrypted in what is referred to as an exportable key container, e.g., exportable key container 630 in FIGS. 6D-6F and exportable key container 730 in FIGS. 7B. An exportable key container is a cryptographically protected data object that helps ensure the secrecy of EKs and prevent unauthorized access to an EK stored within the exportable key container. An exemplary method for generating an exportable key container is illustrated and described with reference to FIGS. 9A-9D.

FIG. 9A illustrates a flowchart of a method 900 for generating an exportable key container. Method 900 begins with a cryptographer module of an application generating an EKₙ and a corresponding key encryption key (KEK). This can be seen in FIG. 9B, where a cryptographer module 910 of an application 930 (see FIG. 9C), e.g., user application 109 or management system application 113, generating an EKₙ and a KEK 905. Generating these keys can include cryptographer module 910 generating two random cryptographic keys that can be used with known symmetric encryption methods, including but not limited to AES. EKₙ and KEK 905 can be generated using a secure random number generator, such as but not limited to a DRBG (deterministic random bit generator), or by a standard symmetric key generation algorithm, such as but not limited to a KBKDF (key-based key derivation function). Next, the cryptographer module encrypts EKₙ with the KEK. This can include cryptographer module 910 encrypting EKₙ with KEK 905 in an AES cipher in a standard block cipher mode, such as but not limited to, Cipher Block Chaining (AES-CBC), Galois Counter Mode (AES-GCM), and Galois Counter Mode with Synthetic IV (AES-GCM-SIV). This encryption produces an encrypted data object referred to as an inner wrapper 920E (see, e.g., FIG. 9B). Next, cryptographer module 910 computes a checksum 904 of the inner wrapper 920E. Checksum 904 can be computed using a standard message digest algorithm from the SHA-2 or SHA-3 family. Next cryptographer module 910 constructs container wrapper 906 by concatenating KEK 905 and checksum 904 according to KEK 905|checksum 904. Next, cryptographer module constructs associated data object 907 which contains metadata about EKₙ encrypted in inner wrapper 920E and the corresponding user associated with cryptographer module 910, including but limited to, an EK IDₙ 711 corresponding to EKₙ, a user ID 913 of the user associated with cryptographer module 910, and a creation time 914 corresponding to the time when container wrapper 906 is constructed. Further, cryptographer module 910 transmits container wrapper 906 and associated data object 907 to KMS 950.

Once the container wrapper is constructed, the container wrapper is encrypted with an MK of the user. This includes cryptographer module 910 of application 930 transmitting container wrapper 906 to a KMS, e.g., KMS 950 illustrated in FIG. 9C. This also includes cryptographer module 910 transmitting AD 907 to KMS 950. Next, as illustrated in FIG. 9D, a cryptographer module 960 of KMS 950 can then identify a MK_{U} associated with the user from MK repository 940 and encrypt container wrapper 906 to generate an encrypted container wrapper 906E. Cryptographer module 960 can encrypt container wrapper 906 according to a standard AEAD encryption method such as, but not limited to, AES-GCM, AES-CCM or AES-GCM-SIV, utilizing AD 907 as the associated data of the AEAD method used. Prior to encrypting container wrapper 906, cryptographer module 960 of KMS 950 can update AD 907 with a MK_{U} ID corresponding to MK_{U} used to encrypt container wrapper 906E and generate an augmented AD 907A.

Once the container wrapper is encrypted with the MK, the KMS can transmit the encrypted container wrapper and the associated data to the application. As illustrated in FIG. 9E, this can include cryptographer module 960 of KMS 950 transmitting encrypted container wrapper 906E and augmented AD 907A to cryptographer module 910 of application 930. Lastly, upon receipt of the encrypted container wrapper and the augmented associated data, the cryptographer module of the application generates an exportable key container. As illustrated in FIG. 9F, this can include cryptographer module 910 concatenating augmented AD 907A, encrypted container wrapper 906E, and inner wrapper 920E together according to “augmented AD 907A”|“encrypted container wrapper 906E”|“inner wrapper” 920E to generate exportable key container 970.

FIGS. 10A-10E illustrate an exemplary method 1000 for extracting an EK from an exportable key container. As shown in the flowchart illustrated in FIG. 10A, this can include a cryptographer module of an application first extracting the components of the exportable key container. With reference to exportable key container 970 constructed in FIG. 9F, this can include cryptographer module 910 separating exportable key container 970 into its component parts, including augmented AD 907A, encrypted container wrapper 906E, and inner wrapper 920E. Next, because encrypted container wrapper 906E is encrypted with MK_{U} of the user associated with cryptographer module 910, which resides within the boundary of KMS 950, cryptographer module 910 proceeds to transmit augmented AD 907A and encrypted container wrapper 906E to KMS 950 for decryption. Upon receipt, as illustrated in FIG. 10C, cryptographer module 960 of KMS 950 can identify the MK_{U} ID indicated in augmented AD 907A, retrieve the corresponding MK_{U} from MK repository 940, and use MK_{U} to decrypt encrypted container wrapper 906E. The resulting data object is container wrapper 906. Then, as illustrated in FIG. 10D, KMS 950 transmits container wrapper 906 back to cryptographer module 910 of application 930.

Referring to FIG. 10E, upon receipt of container wrapper 906, cryptographer module 910 deconstructs container wrapper 906 to extract encrypted KEK 905 and checksum 904. Cryptographer module 910 then computes a checksum of inner wrapper 920E and compares it to checksum 904 of container wrapper 906. If the computed checksum of inner wrapper 920E matches checksum 904 of container wrapper 906, then cryptographer module 910 proceeds to decrypt inner wrapper 920E with KEK 905, revealing EKₙ. EKₙ can then be used to encrypt a data object, as discussed with reference to FIG. 8, or to decrypt an encrypted data object, as discussed with reference to FIG. 11. If the checksum of inner wrapper 920E does not match checksum 904, then method 1000 terminates.

With reference to FIGS. 11A and 11B, an exemplary method 1100 for decrypting a sealed data envelope, e.g., sealed data envelope 850 illustrated in FIG. 8C, is described. Method 1100 begins with a cryptographer module 807 of an application extracting the components of the data envelope. As illustrated in FIG. 11B, this can include cryptographer module 807 separating data envelope 850 into its component parts, which include associated data 806, envelope seal 805, and encrypted data object 820E. Next, cryptographer module 807 retrieves Exportable Key ID 811 from the AD 806 and checks if a key with said exportable key ID is present in the local EK cache 850.

If an EKₙ with an EK ID matching exportable key ID 811 is present in local EK cache 850, cryptographer module 807 proceeds to decrypt data envelope 850. Alternatively, if local cache 850 does not have an EK with an EK ID matching exportable key ID 811 stored therein, then cryptographer module 807 can request the EK corresponding to exportable key ID 811 from an SMS as discussed with reference to FIG. 7B. Because SMS returns an exportable key container with EKₙ stored therein, cryptographer module 807 can extract EKₙ from the exportable key container according to method 1000 described with respect to FIGS. 10A-10E and store the bits of EKₙ in local cache 1100.

Next, cryptographer module 807 decrypts envelope seal 805 using EKₙ and associated data object 806. Once envelope seal 805 is decrypted, cryptographer module 807 extracts checksum key (HK) 810 from envelope seal 805 and uses checksum key 810 to compute a checksum of the encrypted data object 820E. If the computed checksum matches checksum 804 in AD 806, cryptographer module 807 decrypts encrypted data object 820E using transient key TK 808. If the computed checksum 1130 does not match checksum 804 in AD 806, cryptographer module 807 exits method 1100.

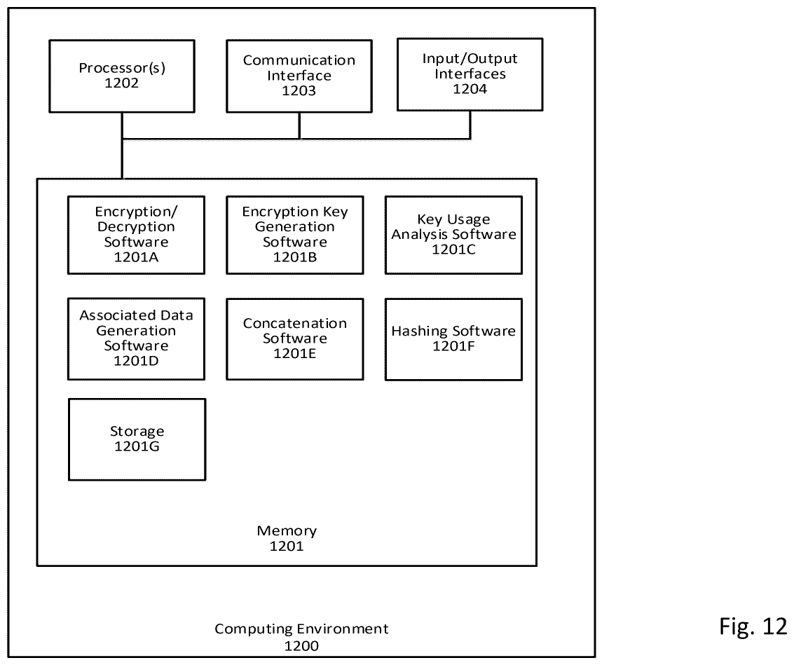

FIG. 12 illustrates an exemplary specialized computing environment for format-preserving encryption of a numerical value. Computing environment 800 includes a memory 1201 that is a non-transitory computer-readable medium and can be volatile memory (e.g., registers, cache, RAM), non-volatile memory (e.g., ROM, EEPROM, flash memory, etc.), or some combination of the two.

As shown in FIG. 8, memory 1201 stores order preserving encryption/decryption software 1201A, encryption key generation software 1201B, key usage analysis software 1201C, associated data generation software 1201D, concatenation software 1201E, hashing software 1201F. The software stores specialized instructions and data structures configured to perform the order preserving encryption and decryption techniques described herein.

Memory 1201 additionally includes a storage 1201G that can be used to store key usage metrics, user data, encrypted or decrypted values, intermediate values required for encryption or decryption (such as chunks of plaintext values and chunks of ciphertext values), and encryption and/or decryption keys, including exportable key containers.

All of the software stored within memory 1201 can be stored as a computer-readable instructions, that when executed by one or more processors 1202, cause the processors to perform the functionality described with respect to FIGS. 1-11.

Processor(s) 1202 execute computer-executable instructions and can be a real or virtual processors. In a multi-processing system, multiple processors or multicore processors can be used to execute computer-executable instructions to increase processing power and/or to execute certain software in parallel.

The computing environment additionally includes a communication interface 1203, such as a network interface, which is used to monitor network communications, communicate with devices, applications, or processes on a computer network or computing system, collect data from devices on the network, and implement encryption/decryption actions on network communications within the computer network or on data stored in databases of the computer network. The communication interface conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Computing environment 1200 further includes input and output interfaces 1204 that allow users (such as system administrators) to provide input to the system and display or otherwise transmit information for display to users. For example, input/output interfaces 1204 can be used to configure encryption/decryption rules and settings, and perform lookups of system information used in the above-described processes.

An interconnection mechanism (shown as a solid line in FIG. 12), such as a bus, controller, or network interconnects the components of the computing environment 1200.

Input and output interfaces 1204 can be coupled to input and output devices. The input device(s) can be a touch input device such as a keyboard, mouse, pen, trackball, touch screen, or game controller, a voice input device, a scanning device, a digital camera, remote control, or another device that provides input to the computing environment. The output device(s) can be a display, television, monitor, printer, speaker, or another device that provides output from the computing environment 1200. Displays can include a graphical user interface (GUI) that presents options to users such as system administrators for configuring encryption and decryption processes.

The computing environment 1200 can additionally utilize a removable or nonremovable storage, such as magnetic disks, magnetic tapes or cassettes, CD-ROMs, CD-RWs, DVDs, USB drives, or any other medium which can be used to store information and can be accessed within the computing environment 1200.

The computing environment 1200 can be a set-top box, personal computer, a client device, a database or databases, or one or more servers, for example a farm of networked servers, a clustered server environment, or a cloud network of computing devices and/or distributed databases.

Having described and illustrated the principles of our invention with reference to the described embodiment, it will be recognized that the described embodiment can be modified in arrangement and detail without departing from such principles. Elements of the described embodiment shown in software can be implemented in hardware and vice versa.

In view of the many possible embodiments to which the principles of our invention can be applied, we claim as our invention all such embodiments as can come within the scope and spirit of the following claims and equivalents thereto.

We claim:

1. A method for encryption key management executed by one or more computing devices of a management system, the method comprising:
receiving an encryption request from an application, the encryption request comprising a request to encrypt at least one data object, wherein the application is associated with a corresponding user;
determining a usage metric of each of a plurality of existing encryption keys associated with the corresponding user, each usage metric comprising a number of data objects encrypted by a respective existing encryption key;
determining whether to transmit an existing encryption key in the plurality of existing encryption keys to the application or to transmit instructions to the application configured to cause the application to generate a new encryption key, the determination being based at least in part on a probabilistic model, the usage metric for each of the plurality of existing encryption keys, and a data loss threshold associated with the corresponding user;
transmitting, to the application, either the existing encryption key or the instructions configured to cause the application to generate the new encryption key.

2. The method of claim 1, wherein transmitting, to the application, either the existing encryption key or the instructions configured to cause the application to generate the new encryption key comprises transmitting the existing encryption key an further comprises:
selecting the existing encryption key from an encryption key repository; and
transmitting an encryption key container corresponding to the selected existing encryption key to the application, wherein the encryption key container is an encrypted data object containing the selected existing encryption key.

3. The method of claim 2, wherein the encryption key container comprises:
an encrypted encryption key corresponding to the selected existing encryption key, wherein the encrypted encryption key is encrypted with a key encryption key;
an encrypted container wrapper comprising the key encryption key and a checksum of the encrypted encryption key, wherein the encrypted container wrapper is encrypted with a master key associated with the user; and
an augmented associated data object comprising metadata corresponding to the selected existing encryption key, the corresponding user, and the master key used to encrypt the encrypted container wrapper.

4. The method of claim 1, wherein transmitting, to the application, either the existing encryption key or the instructions configured to cause the application to generate the new encryption key comprises transmitting the instructions configured to cause the application to generate the new encryption key and further comprising:
receiving, from the application, an encryption key container corresponding to the new encryption key generated by the application, wherein the encryption key container is an encrypted data object containing the new encryption key generated by the application; and
storing the encryption key container corresponding to the new encryption key generated by the application.

5. The method of claim 1, wherein the instructions configured to cause the application to generate a new encryption key are further configured to cause the application to:
generate an encryption key container corresponding to the new encryption key, wherein the encryption key container is an encrypted data object containing the new encryption key; and
encrypt the data object with the new encryption key.

6. The method of claim 5, wherein the instructions configured to cause the application to generate the encryption key container corresponding to the new encryption key are configured to cause the application to:
generate a key encryption key;
encrypt the new encryption key with the key encryption key to generate an encrypted encryption key;
determine a checksum of the encrypted encryption key;
concatenate the key encryption key and the checksum of the encrypted encryption key to generate a container wrapper;
transmit the container wrapper and an associated data object to the management system, wherein the associated data object comprises metadata about the new encryption key and the corresponding user;
receive, from the management system, an encrypted container wrapper and an augmented associated data object, wherein the encryption key encryption key is encrypted by the management system with a master encryption key associated with the corresponding user, and wherein the augmented associated data object comprises metadata corresponding to the new encryption key, the corresponding user, and the master key; and
concatenate the augmented associated data object, the encrypted container wrapper, and the encrypted encryption key to generate the encryption key container.

7. The method of claim 1, wherein determining whether to transmit an existing encryption key in the plurality of existing encryption keys to the application or to transmit instructions to the application configured to cause the application to generate a new encryption key comprises:
determining a probability that that use of an existing encryption key to encrypt the data object will cause the data loss threshold associated with the corresponding user to be exceeded based at least in part on the usage metric for each of the plurality of existing encryption keys, a total number of existing encryption keys associated with the corresponding user, and the data loss threshold associated with the corresponding user;
determining whether the probability exceeds a threshold probability value; and
determining whether to transmit an existing encryption key in the plurality of existing encryption keys to the application or to transmit instructions to the application configured to cause the application to generate a new encryption key based at least in part on whether the probability exceeds the threshold probability value.

8. An apparatus for encryption key management, the apparatus comprising:
one or more processors; and
one or more memories operatively coupled to at least one of the one or more processors and having instructions stored thereon that, when executed by at least one of the one or more processors, cause at least one of the one or more processors to:
receive an encryption request from an application, the encryption request comprising a request to encrypt at least one data object, wherein the application is associated with a corresponding user;
determine a usage metric of each of a plurality of existing encryption keys associated with the corresponding user, each usage metric comprising a number of data objects encrypted by a respective existing encryption key;
determine whether to transmit an existing encryption key in the plurality of existing encryption keys to the application or to transmit instructions to the application configured to cause the application to generate a new encryption key, the determination being based at least in part on a probabilistic model, the usage metric for each of the plurality of existing encryption keys, and a data loss threshold associated with the corresponding user;
transmit, to the application, either the existing encryption key or the instructions configured to cause the application to generate the new encryption key.

9. The apparatus of claim 8, wherein the instructions that, when executed by at least one of the one or more processors, cause at least one of the one or more processors to transmit, to the application, either the existing encryption key or the instructions configured to cause the application to generate the new encryption key cause the at least one of the one or more processors to transmit the existing encryption key and further cause the at least one of the one or more processors to:
select the existing encryption key from an encryption key repository; and
transmit an encryption key container corresponding to the selected existing encryption key to the application, wherein the encryption key container is an encrypted data object containing the selected existing encryption key.

10. The apparatus of claim 9, wherein the encryption key container comprises:
an encrypted encryption key corresponding to the selected existing encryption key, wherein the encrypted encryption key is encrypted with a key encryption key;
an encrypted container wrapper comprising the key encryption key and a checksum of the encrypted encryption key, wherein the encrypted container wrapper is encrypted with a master key associated with the user; and
an augmented associated data object comprising metadata corresponding to the selected existing encryption key, the corresponding user, and the master key used to encrypt the encrypted container wrapper.

11. The apparatus of claim 8, wherein the instructions that, when executed by at least one of the one or more processors, cause at least one of the one or more processors to transmit, to the application, either the existing encryption key or the instructions configured to cause the application to generate the new encryption key cause the at least one of the one or more processors to transmit the instructions configured to cause the application to generate the new encryption key and further cause the at least one of the one or more processors to:
receive, from the application, an encryption key container corresponding to the new encryption key generated by the application, wherein the encryption key container is an encrypted data object containing the new encryption key generated by the application; and
store the encryption key container corresponding to the new encryption key generated by the application.

12. The apparatus of claim 8, the instructions configured to cause the application to generate the new encryption key are further configured to cause the application to:
generate an encryption key container corresponding to the new encryption key, wherein the encryption key container is an encrypted data object containing the new encryption key; and
encrypt the data object with the new encryption key.

13. The apparatus of claim 12, wherein the instructions configured to cause the application to generate the encryption key container corresponding to the new encryption key are configured to cause the application to:
generate a key encryption key;
encrypt the new encryption key with the key encryption key to generate an encrypted encryption key;
determine a checksum of the encrypted encryption key;
concatenate the key encryption key and the checksum of the encrypted encryption key to generate a container wrapper;
transmit the container wrapper and an associated data object to the management system, wherein the associated data object comprises metadata about the new encryption key and the corresponding user;
receive, from the management system, an encrypted container wrapper and an augmented associated data object, wherein the encryption key encryption key is encrypted by the management system with a master encryption key associated with the corresponding user, and wherein the augmented associated data object comprises metadata corresponding to the new encryption key, the corresponding user, and the master key; and
concatenate the augmented associated data object, the encrypted container wrapper, and the encrypted encryption key to generate the encryption key container.

14. The apparatus of claim 8, wherein the instructions that, when executed by at least one of the one or more processors, cause at least one of the one or more processors to determine whether to transmit an existing encryption key in the plurality of existing encryption keys to the application or to transmit instructions to the application configured to cause the application to generate a new encryption key further cause the at least one of the one or more processors to:
determine a probability that that use of an existing encryption key to encrypt the data object will cause the data loss threshold associated with the corresponding user to be exceeded based at least in part on the usage metric for each of the plurality of existing encryption keys, a total number of existing encryption keys associated with the corresponding user, and the data loss threshold associated with the corresponding user;
determine whether the probability exceeds a threshold probability value; and
determine whether to transmit an existing encryption key in the plurality of existing encryption keys to the application or to transmit instructions to the application configured to cause the application to generate a new encryption key based at least in part on whether the probability exceeds the threshold probability value.

15. At least one non-transitory computer-readable medium storing computer-readable instructions that, when executed by at least one of one or more computing devices, cause at least one of the one or more computing devices to:
receive an encryption request from an application, the encryption request comprising a request to encrypt at least one data object, wherein the application is associated with a corresponding user;
determine a usage metric of each of a plurality of existing encryption keys associated with the corresponding user, each usage metric comprising a number of data objects encrypted by a respective existing encryption key;
determine whether to transmit an existing encryption key in the plurality of existing encryption keys to the application or to transmit instructions to the application configured to cause the application to generate a new encryption key, the determination being based at least in part on a probabilistic model, the usage metric for each of the plurality of existing encryption keys, and a data loss threshold associated with the corresponding user;
transmit, to the application, either the existing encryption key or the instructions configured to cause the application to generate the new encryption key.

16. The at least one non-transitory computer-readable medium of claim 15, wherein the instructions that, when executed by at least one of the one or more computing devices, cause at least one of the one or more computing devices to transmit, to the application, either the existing encryption key or the instructions configured to cause the application to generate the new encryption key cause the at least one of the one or more computing devices to transmit the existing encryption key and further cause the at least one of the one or more computing devices to:
select the existing encryption key from an encryption key repository; and
transmit an encryption key container corresponding to the selected existing encryption key to the application, wherein the encryption key container is an encrypted data object containing the selected existing encryption key.

17. The at least one non-transitory computer-readable medium of claim 16, wherein the encryption key container comprises:
an encrypted encryption key corresponding to the selected existing encryption key, wherein the encrypted encryption key is encrypted with a key encryption key;
an encrypted container wrapper comprising the key encryption key and a checksum of the encrypted encryption key, wherein the encrypted container wrapper is encrypted with a master key associated with the user; and
an augmented associated data object comprising metadata corresponding to the selected existing encryption key, the corresponding user, and the master key used to encrypt the encrypted container wrapper.

18. The at least one non-transitory computer-readable medium of claim 15, wherein the instructions that, when executed by at least one of the one or more computing devices, cause at least one of the one or more computing devices to transmit, to the application, either the existing encryption key or the instructions configured to cause the application to generate the new encryption key cause the at least one of the one or more computing devices to transmit the instructions configured to cause the application to generate the new encryption key and further cause the at least one of the one or more computing devices to:
receive, from the application, an encryption key container corresponding to the new encryption key generated by the application, wherein the encryption key container is an encrypted data object containing the new encryption key generated by the application; and
store the encryption key container corresponding to the new encryption key generated by the application.

19. The at least one non-transitory computer-readable medium of claim 15, the instructions configured to cause the application to generate the new encryption key are further configured to cause the application to:
generate a key encryption key;
encrypt the new encryption key with the key encryption key to generate an encrypted encryption key;
determine a checksum of the encrypted encryption key;
concatenate the key encryption key and the checksum of the encrypted encryption key to generate a container wrapper;
transmit the container wrapper and an associated data object to the management system, wherein the associated data object comprises metadata about the new encryption key and the corresponding user;
receive, from the management system, an encrypted container wrapper and an augmented associated data object, wherein the encryption key encryption key is encrypted by the management system with a master encryption key associated with the corresponding user, and wherein the augmented associated data object comprises metadata corresponding to the new encryption key, the corresponding user, and the master key; and
concatenate the augmented associated data object, the encrypted container wrapper, and the encrypted encryption key to generate the encryption key container; and
encrypt the data object with the new encryption key.

20. The at least one non-transitory computer-readable medium of claim 15, wherein the instructions that, when executed by at least one of the one or more computing devices, cause at least one of the one or more computing devices to determine whether to transmit an existing encryption key in the plurality of existing encryption keys to the application or to transmit instructions to the application configured to cause the application to generate a new encryption key further cause the at least one of the one or more computing devices to:
determine a probability that that use of an existing encryption key to encrypt the data object will cause the data loss threshold associated with the corresponding user to be exceeded based at least in part on the usage metric for each of the plurality of existing encryption keys, a total number of existing encryption keys associated with the corresponding user, and the data loss threshold associated with the corresponding user;
determine whether the probability exceeds a threshold probability value; and
determine whether to transmit an existing encryption key in the plurality of existing encryption keys to the application or to transmit instructions to the application configured to cause the application to generate a new encryption key based at least in part on whether the probability exceeds the threshold probability value.
